(19) United States
(12) Patent Application Publication
(10) Pub. No.: US 2024/0329550 A1
(43) Pub. Date: Oct. 3, 2024

(54) ELECTROPHOTOGRAPHIC PHOTORECEPTOR, ELECTROPHOTOGRAPHIC PHOTORECEPTOR CARTRIDGE, AND IMAGE-FORMING APPARATUS

(71) Applicant: MITSUBISHI CHEMICAL CORPORATION, Tokyo (JP)

(72) Inventor: Akira ANDO, Tokyo (JP)

(73) Assignee: MITSUBISHI CHEMICAL CORPORATION, Tokyo (JP)

(21) Appl. No.: 18/672,717

(22) Filed: May 23, 2024

Related U.S. Application Data
(63) Continuation of application No. PCT/JP2022/043381, filed on Nov. 24, 2022.

(30) Foreign Application Priority Data
Nov. 26, 2021 (JP) 2021-191972

(51) Int. Cl. G03G 5/147

(52) U.S. Cl. CPC G03G 5/14734; G03G 5/14704; G03G 2215/00957; G03G 2215/00962

(57) ABSTRACT

The disclosure provides an electrophotographic photoconductor comprises a photosensitive layer and a protective layer in sequence on a conductive support, wherein the protective layer contains a polymer having a structure represented by the following formula (1) or (2):

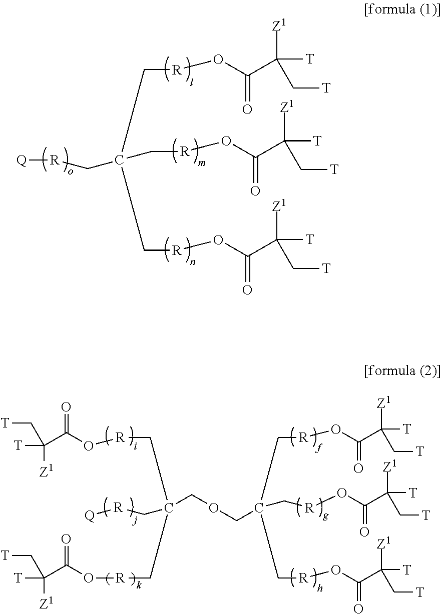

### TECHNICAL FIELD

The present invention relates to an electrophotographic photoconductor used in copiers, printers, and the like, and an electrophotographic photoconductor cartridge and an image-forming apparatus using the same.

### BACKGROUND ART

In printers, copiers, and the like, a charged organic photoconductor (OPC) drum is irradiated with light to form an electrostatic latent image by destaticizing the irradiated portion, and a toner adheres to the electrostatic latent image to provide an image. In devices using such electrophotographic technology, the photoconductor is a key member.

The organic photoconductor of this type leaves much room for material selection and the characteristics of the photoconductor can be easily controlled, and “function-separated photoconductors”, in which the functions of charge generation and transfer are shared by different compounds, are thus becoming mainstream. For example, there are known a single-layered electrophotographic photoconductor (hereinafter referred to as “single-layer photoconductor”) having a charge generation material (CGM) and a charge transport material (CTM) in the same layer, and a multi-layered electrophotographic photoconductor (hereinafter referred to as “multi-layer photoconductor”) having a charge generation layer containing a charge generation material (CGM) and a charge transport layer containing a charge transport material (CTM) laminated on each other. The photoconductor can be charged by a negative charging method, in which the surface of the photoconductor is negatively charged, or by a positive charging method, in which the surface of the photoconductor is positively charged.

The combinations of layer configurations and charging methods of the photoconductor currently in practical use include a “negatively-charged multi-layer photoconductor” and a “positively-charged single-layer photoconductor”.

The “negatively-charged multi-layer photoconductor” generally has a configuration in which an undercoat layer (UCL) made of a resin or the like is provided on a conductive substrate such as an aluminum tube, a charge generation layer (CGL) made of a charge generation material (CGM) and a resin or the like is provided thereon, and a charge transport layer (CTL) made of a hole transport material (HTM) and a resin or the like is further provided thereon.

The “positively-charged single-layer photoconductor” generally has a configuration in which an undercoat layer (UCL) made of a resin or the like is provided on a conductive substrate such as an aluminum tube, and a single-layered photosensitive layer made of a charge generation material (CGM), a hole transport material (HTM), an electron transport material (ETM), and a resin or the like is provided thereon (see, for example, Patent Literature 1).

In both types of photoconductors, the surface of the photoconductor is charged by a corona discharging method or a contact method, and the photoconductor is then exposed to light to neutralize the charge on the surface, thereby forming an electrostatic latent image due to the potential difference with the surrounding surface. Thereafter, a toner is brought into contact with the surface of the photoconductor to form a toner image corresponding to the electrostatic latent image, and the toner image is transferred to paper or the like and heat-melted and fixed to complete printing.

The electrophotographic photoconductor includes, as a basic configuration, a conductive support and a photosensitive layer formed on the conductive support as described above, and further includes a protective layer provided on the photosensitive layer for the purpose of improving abrasion resistance and the like.

As technologies for improving the mechanical strength or abrasion resistance of the surface of the photoconductor, there are disclosed photoconductors in which a layer containing a chain polymerizable functional group-containing compound is formed as the outermost layer of the photoconductor, and is polymerized by applying energy such as heat, light, or radiation to form a cured resin layer (see, for example, Patent Literatures 1 and 2)

### CITATION LIST

### Patent Literature

Patent Literature 1: U.S. Pat. No. 9,417,538
Patent Literature 2: International Publication No. 2010/035683 (U.S. Pat. No. 5,263,296)

### SUMMARY OF THE INVENTION

### Problem to be Solved by the Invention

As the methods for improving the mechanical strength or abrasion resistance of the surface of the photoconductor as described above, there are known methods in which a protective layer is formed using a polyfunctional acrylate or a polyfunctional methacrylate as a curable resin.

However, when a certain type of polyfunctional acrylate or polyfunctional methacrylate is used to form a protective layer, the electrical characteristics are deteriorated, and charges tend to remain after exposure. For example, trimethylolpropane trimethacrylate (TMPT) is relatively easily available and is known as a material having excellent mechanical strength due to its low molecular weight and low functional group equivalent, which allows for high-density crosslinking in three dimensions. Therefore, TMPT is a well-known (meth)acrylate material for forming a protective layer. However, when a protective layer is formed using a certain type of polyfunctional acrylate or polyfunctional methacrylate represented by TMPT, the residual potential characteristics, where charges remain after exposure, tend to deteriorate.

In addition, printers, copiers, and the like have built-in chargers to charge the photoconductor, and the chargers generate acidic gases such as ozone during charging. When the acidic gases penetrate into the protective layer, the gas resistance tends to deteriorate depending on the material used to form the protective layer.

An object of the present invention is to provide a novel electrophotographic photoconductor including a photosensitive layer and a protective layer in sequence on a conductive support, and having a high Martens hardness and an elastic deformation rate on the surface of the photoconductor, yet preventing deterioration of electrical characteristics, such as deterioration of residual potential characteristics, and also having good gas resistance.

### Means for Solving Problem

The present invention solves the above problems by using a compound having a specific structure among multifunctional acrylates or multifunctional methacrylates to form a protective layer.

Specifically, the gist of the present invention is set forth in the following [1] to [11].
[1] An electrophotographic photoconductor including a photosensitive layer and a protective layer in sequence on a conductive support, wherein the protective layer contains a polymer having a structure represented by the following formula (1) or (2).

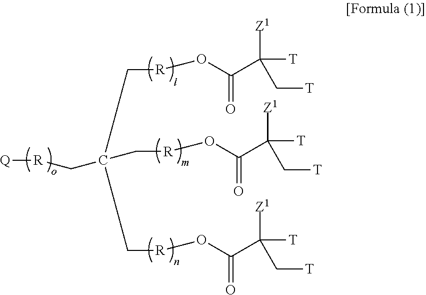

In the formula (1), l, m, n, and o are each an integer of 0 or more and 10 or less, and a sum of l, m, n, and o is 1 or more. Each R independently represents a divalent group selected from an alkylene group having 1 or more and 8 or less carbon atoms, an oxyalkylene group having 1 or more and 8 or less carbon atoms, and —O—(C═O)—(CH₂)ₚ— (where p is 2 or more and 6 or less). T represents a bonding hand with arbitrary atoms. Q represents a hydroxy group or the following formula (3). Each Z¹ independently represents a hydrogen atom or an alkyl group having 1 or more and 4 or less carbon atoms, at least one of which represents an alkyl group having 1 or more and 4 or less carbon atoms.

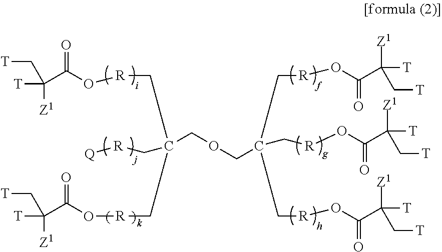

In the formula (2), f, g, h, i, j, and k are each an integer of 0 or more and 10 or less, and a sum of f, g, h, i, j, and k is 1 or more. Each R independently represents a divalent group selected from an alkylene group having 1 or more and 8 or less carbon atoms, an oxyalkylene group having 1 or more and 8 or less carbon atoms, and —O—(C═O)—(CH₂)ₚ— (where p is 2 or more and 6 or less). T represents a bonding hand with arbitrary atoms. Q represents a hydroxy group or the following formula (3). Each Z¹ independently represents a hydrogen atom or an alkyl group having 1 or more and 4 or less carbon atoms, at least one of which represents an alkyl group having 1 or more and 4 or less carbon atoms.

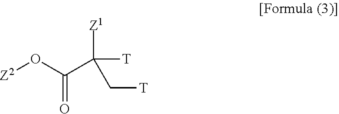

In the formula (3), Z² represents a bonding hand with R in the formula (1) or (2). Z¹ represents a hydrogen atom or an alkyl group having 1 or more and 4 or less carbon atoms. T represents a bonding hand with arbitrary atoms.
[2] The electrophotographic photoconductor according to the above [1], wherein the protective layer contains a polymer having a structure represented by the formula (1).
[3] An electrophotographic photoconductor including a photosensitive layer and a protective layer in sequence on a conductive support, wherein the protective layer contains a polymer of a compound a having a structure represented by the following formula (1′) or a polymer of a compound b having a structure represented by the following formula (2′).

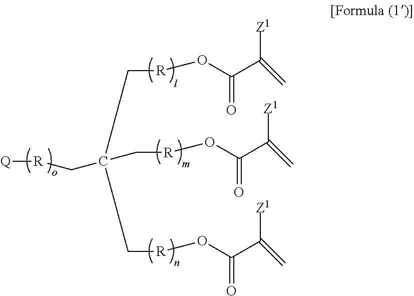

In the formula (1′), l, m, n, and o are each an integer of 0 or more and 10 or less, and a sum of l, m, n, and o is 1 or more. Each R independently represents a divalent group selected from an alkylene group having 1 or more and 8 or less carbon atoms, an oxyalkylene group having 1 or more and 8 or less carbon atoms, and —O—(C═O)—(CH₂)ₚ— (where p is 2 or more and 6 or less). Q represents a hydroxy group or the following formula (3′). Each Z¹ independently represents a hydrogen atom or an alkyl group having 1 or more and 4 or less carbon atoms, at least one of which represents an alkyl group having 1 or more and 4 or less carbon atoms.

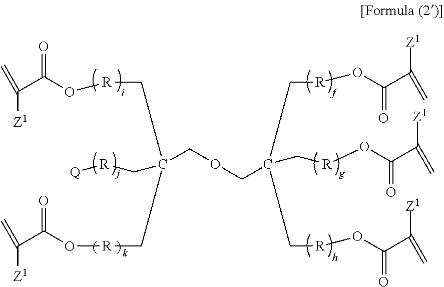

In the formula (2′), f, g, h, i, j, and k are each an integer of 0 or more and 10 or less, and a sum of f, g, h, i, j, and k is 1 or more. Each R independently represents a divalent group selected from an alkylene group having 1 or more and 8 or less carbon atoms, an oxyalkylene group having 1 or more and 8 or less carbon atoms, and —O—(C═O)—(CH₂)ₚ— (where p is 2 or more and 6 or less). Q represents a hydroxy group or the following formula (3′). Each Z¹ independently represents a hydrogen atom or an alkyl group having 1 or more and 4 or less carbon atoms, at least one of which represents an alkyl group having 1 or more and 4 or less carbon atoms.

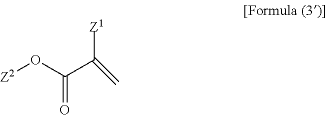

In the formula (3′), Z² represents a bonding hand with R in the formula (1′) or (2′). Z¹ represents a hydrogen atom or an alkyl group having 1 or more and 4 or less carbon atoms.
[4] The electrophotographic photoconductor according to the above [3], including a photosensitive layer and a protective layer in sequence on a conductive support,
wherein the protective layer contains a polymer of a compound a having a structure represented by the formula (1′).
[5] The electrophotographic photoconductor according to any one of the above [1] to [4], wherein each R in the formula (1), (2), (1′), or (2′) represents an oxyalkylene group having 1 or more and 8 or less carbon atoms.
[6] The electrophotographic photoconductor according to any one of the above [1] to [5], wherein the protective layer contains metal oxide particles.
[7] The electrophotographic photoconductor according to any one of the above [1] to [6], wherein the protective layer is a layer cured by irradiation with ultraviolet light and/or visible light.
[8] The electrophotographic photoconductor according to any one of the above [1] to [7], wherein the photosensitive layer is a single-layer type photosensitive layer containing both a charge generation material and a charge transport material in the same layer.
[9] The electrophotographic photoconductor according to the above [3] or [4], wherein a molecular weight X of the compound a or b represented by the formula (1′) or (2′) and a number Y of acryloyl and methacryloyl groups in one molecule satisfy the following formula (4).

120≤X/Y≤400 (4)
[10] The electrophotographic photoconductor according to the above [3] or [4], wherein the molecular weight X of the compound a or b represented by the formula (1′) or (2′) is 550 or more and 1,400 or less.
[11] The electrophotographic photoconductor according to any one of the above [1] to [10], wherein l, m, n, and o in the formula (1) or (1′) are each an integer of 0 or more and 8 or less.
[12] The electrophotographic photoconductor according to any one of the above [1] to [11], wherein a sum of 1, m, n, and o in the formula (1) or (1′) is 1 or more and 12 or less.
[13] The electrophotographic photoconductor according to any one of the above [1] to [12], wherein a sum of f, g, h, i, j, and k in the formula (2) or (2′) is 1 or more and 18 or less.
[14] An electrophotographic photoconductor including a photosensitive layer and a protective layer in sequence on a conductive support,
wherein the protective layer contains a polymer having a group represented by the following R′, a structure represented by the following formula (5), and a structure represented by the following formula (6).
R′ represents a divalent group selected from an alkylene group having 1 or more and 8 or less carbon atoms, an oxyalkylene group having 1 or more and 8 or less carbon atoms, and —O—(C═O)—(CH₂)ₚ— (where p is 2 or more and 6 or less).

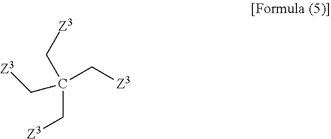

In the formula (5), Z³ represents a bonding hand with arbitrary atoms.

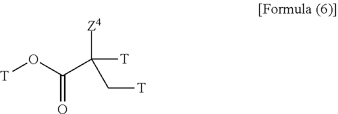

In the formula (6), Z⁴ represents an alkyl group having 1 or more and 4 or less carbon atoms. T represents a bonding hand with arbitrary atoms.
[15] An electrophotographic photoconductor cartridge including the electrophotographic photoconductor according to any one of the above [1] to [14].
[16] An image-forming apparatus including the electrophotographic photoconductor according to any one of the above [1] to [14].

### Effect of the Invention

The electrophotographic photoconductor of the present invention has a high Martens hardness and an elastic deformation rate on the surface of the photoconductor, yet it prevents deterioration of electrical characteristics, such as deterioration of residual potential characteristics where charges remain after exposure, and also has good gas resistance.

### BRIEF DESCRIPTION OF DRAWINGS

FIG. 1 shows a schematic diagram of an example configuration of an image-forming apparatus that can be configured using an electrophotographic photoconductor according to one example of the present invention.

FIG. 2 shows a graph of a general relationship between the indentation depth of an indenter and the load curve when measuring the Martens hardness and the elastic deformation rate of the photoconductor.

### MODE(S) FOR CARRYING OUT THE INVENTION

Modes for carrying out the present invention (hereinafter referred to as embodiments of the present invention) are described in detail below. The present invention is not to be limited to the following embodiments, and may be implemented with various modifications within the scope of the gist thereof.

### <<Present Electrophotographic Photoconductor>>

The electrophotographic photoconductor according to an example of the embodiments of the present invention (also referred to as “the present electrophotographic photoconductor”) is an electrophotographic photoconductor including a photosensitive layer and a protective layer in sequence on a conductive support, and the protective layer preferably contains a cured product obtained by curing a curable compound.

The present electrophotographic photoconductor may optionally include other layers in addition to the photosensitive layer and the protective layer.

The charging method of the present electrophotographic photoconductor may be either a negative charging method in which the surface of the photoconductor is negatively charged, or a positive charging method in which the surface of the photoconductor is positively charged.

In the present electrophotographic photoconductor, the side opposite to the conductive support is an upper side or a front surface side, and the conductive support side is a lower side or a back surface side. From the viewpoint of obtaining more of the effects of the present invention, the protective layer is preferably the outermost layer.

### <Present Protective Layer>

The protective layer of the present electrophotographic photoconductor (also referred to as “the present protective layer”) is preferably a layer containing a polymer A having a structure represented by the following formula (1) or a polymer B having a structure represented by the following formula (2).

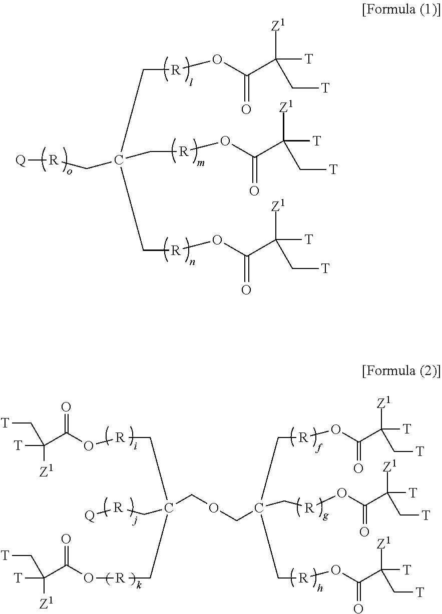

In addition, the present protective layer is preferably a layer containing a polymer A′ of a compound a having a structure represented by the following formula (1′) or a polymer B′ of a compound b having a structure represented by the following formula (2′). In other words, the present protective layer contains a cured product obtained by curing a curable compound, and the curable compound is preferably a compound having a structure represented by the following formula (1′) or a compound having a structure represented by the following formula (2′).

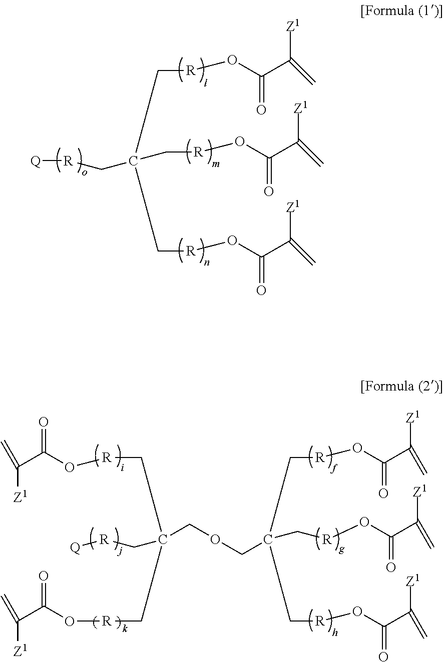

As described above, it has been observed that when trimethylolpropane trimethacrylate (TMPT) is used to form a protective layer, the residual potential characteristics where charges remain after exposure tend to deteriorate. The cause of this is presumed by the present inventors as follows. The alkyl side chain that TMPT has in its molecule has a non-polar structure. The main components of the photosensitive layer, such as binder resins, hole transport materials, and electron transport materials, also have a relatively non-polar structure. Therefore, the affinity between TMPT and the photosensitive layer is high, and when TMPT is used to form a protective layer, for example, when a protective layer-forming coating liquid is coated on the surface of the photosensitive layer followed by heating and drying, or by curing thereafter, a layer (mixed layer) of mixing of the components of the protective layer and the photosensitive layer is easily formed between the two layers. This mixed layer inhibits charge transport from the photosensitive layer to the protective layer, which is considered to be a deterioration of the electrical characteristics, especially the residual potential characteristics.

In contrast, the structure represented by the formula (1), (2), (1′), or (2′) does not have a side chain with low polarity as in the alkyl group, and has a structure in which groups with relatively high polarity C═O bonds (such as acryloyl and methacryloyl groups) or hydroxy groups are located on the outside of the molecule. The affinity between these polar groups located on the outside of the molecule and the relatively low-polarity photosensitive layer is low. Therefore, when forming the present protective layer, especially when coating the protective layer-forming coating liquid on the surface of the photosensitive layer followed by heating and drying, the formation of a layer (mixed layer) of mixing of the components of the protective layer and the photosensitive layer can be suppressed between the two layers, and as a result, it is considered that the deterioration of the electrical characteristics, especially the residual potential characteristics, can be prevented.

In addition, the structure represented by the formula (1), (2), (1′), or (2′) has at least one or more Z¹ being an alkyl group having 1 or more and 4 or less carbon atoms. With this configuration, acidic gases such as ozone generated inside the printer are sterically inhibited from approaching the unreacted carbon-carbon double bond to which Z¹ is bonded, thereby suppressing oxidative deterioration of the carbon-carbon double bond, which is considered to result in good gas resistance.

### [Formulae (1) and (1′)]

In the formulae (1) and (1′), l, m, n, and o are each an integer of 0 or more and 10 or less. Among them, each is preferably an integer of 1 or more, while each is preferably an integer of 8 or less, more preferably 4 or less, and even more preferably 2 or less.

The sum of l, m, n, and o represents an equivalent amount of connecting chains R contained in the formulae (1) and (1′); and the sum is preferably 1 or more from the viewpoint of suppressing steric repulsion between groups having C═O bonds (such as (meth)acryloyl groups) located at the terminal side of the molecule and preventing the release of the groups having C═O bonds (such as (meth)acryloyl groups), and more preferably 2 or more. In addition, it is preferably 20 or less from the viewpoint of mechanical strength of the protective layer, more preferably 12 or less, even more preferably 6 or less, and particularly preferably 4 or less.

In the formulae (1) and (1′), the presence of connecting chains R suppresses steric repulsion between groups having C═O bonds (such as (meth)acryloyl groups) located at the terminal side of the molecule and prevents the release of the groups having C═O bonds (such as (meth)acryloyl groups). From such a viewpoint, each R is independently a divalent group selected from an alkylene group having 1 or more and 8 or less carbon atoms, an oxyalkylene group having 1 or more and 8 or less carbon atoms, and —O—(C═O)—(CH₂)ₚ— (where p is 2 or more and 6 or less). Among them, from the viewpoint of ease of synthesis, it is preferably an oxyalkylene group having 1 or more and 8 or less carbon atoms.

Examples of the oxyalkylene group having 1 or more and 8 or less carbon atoms include —O—CH₂—, —O—CH₂—CH₂—, —O—CH(CH₃)—CH₂—, —O—CH₂—CH(CH₃)—, —O—CH₂—CH₂—CH₂—, and —O—CH₂—CH₂—CH₂—CH₂—. Among them, —O—CH₂—CH₂— and —O—CH(CH₃)—CH₂— are preferred, and —O—CH₂—CH₂— is more preferred.

When the connecting chains R are oxyalkylene groups having 1 or more and 8 or less carbon atoms, the number of the oxyalkylene groups in one molecule of the compound a having the structure represented by formula (1′) is preferably 2 or more, more preferably 4 or more. In addition, it is preferably 12 or less, more preferably 10 or less, and even more preferably 6 or less.

In the formula (1), T represents a bonding hand with arbitrary atoms. For example, carbon, hydrogen, nitrogen, and oxygen are assumed as the arbitrary atoms.

In the formula (1), Q is preferably a hydroxy group or the following formula (3) from the viewpoint of having polarity and suppressing the formation of a mixed layer.

Q in the formula (1′) is also preferably a hydroxy group or the following formula (3′) from the viewpoint of having polarity and suppressing the formation of a mixed layer.

In the formulae (1) and (1′), each Z¹ independently represents a hydrogen atom or an alkyl group having 1 or more and 4 or less carbon atoms, at least one of which is preferably an alkyl group having 1 or more and 4 or less carbon atoms. In the formulae (1) and (1′), it is more preferred that two or more of Z¹ are alkyl groups having 1 or more and 4 or less carbon atoms, it is even more preferred that three or more of Z¹ are alkyl groups having 1 or more and 4 or less carbon atoms, and it is particularly preferred that all of Z¹ are alkyl groups having 1 or more and 4 or less carbon atoms. The more Z¹ is an alkyl group having 1 or more and 4 or less carbon atoms, the better the gas resistance, because acidic gases such as ozone are sterically inhibited from approaching the unreacted carbon-carbon double bond to which Z¹ is bonded.

When Z¹ in the formulae (1) and (1′) is an alkyl group having 1 or more and 4 or less carbon atoms, the number of carbon atoms in the alkyl group is preferably 1 or more and 3 or less, more preferably 1 or more and 2 or less, and even more preferably 1, i.e., a methyl group.

### [Formulae (2) and (2′)]

In the formulae (2) and (2′), f, g, h, i, j, and k are each an integer of 0 or more and 10 or less. Among them, each is preferably an integer of 1 or more, while each is preferably an integer of 8 or less, more preferably 4 or less, and even more preferably 2 or less.

The sum of f, g, h, i, j, and k represents an equivalent amount of connecting chains R contained in the formulae (2) and (2′); and the sum is preferably 1 or more from the viewpoint of suppressing steric repulsion between groups having C═O bonds (such as (meth)acryloyl groups) located at the terminal side of the molecule and preventing the release of the groups having C═O bonds (such as (meth)acryloyl groups), more preferably 2 or more, and particularly preferably 4 or more. In addition, it is preferably 20 or less from the viewpoint of mechanical strength of the protective layer, more preferably 18 or less, even more preferably 12 or less, and particularly preferably 6 or less.

In the formulae (2) and (2′), from the viewpoint of suppressing steric repulsion between groups having C═O bonds (such as (meth)acryloyl groups) located at the terminal side of the molecule and preventing the release of the groups having C═O bonds (such as (meth)acryloyl groups), it is preferred that each R is independently a divalent group selected from an alkylene group having 1 or more and 8 or less carbon atoms, an oxyalkylene group having 1 or more and 8 or less carbon atoms, and —O—(C═O)—(CH₂)ₚ— (where p is 2 or more and 6 or less). Among them, from the viewpoint of ease of synthesis, it is preferably an oxyalkylene group having 1 or more and 8 or less carbon atoms.

Examples of the oxyalkylene group having 1 or more and 8 or less carbon atoms include —O—CH₂—, —O—CH₂—CH₂—, —O—CH(CH₃)—CH₂—, —O—CH₂—CH(CH₃)—, —O—CH₂—CH₂—CH₂—, and —O—CH₂—CH₂—CH₂—CH₂—. Among them, —O—CH₂—CH₂— and —O—CH(CH₃)—CH₂— are preferred, and —O—CH₂—CH₂— is more preferred.

When the connecting chains R are oxyalkylene groups having 1 or more and 8 or less carbon atoms, the number of the oxyalkylene groups in one molecule of the compound b having the structure represented by formula (2′) is preferably 2 or more, more preferably 4 or more. In addition, it is preferably 12 or less, more preferably 10 or less, and even more preferably 6 or less.

In the formula (2), T represents a bonding hand with arbitrary atoms. For example, carbon, hydrogen, nitrogen, and oxygen are assumed as the arbitrary atoms.

In the formula (2), Q is preferably a hydroxy group or the following formula (3) from the viewpoint of having polarity and suppressing the formation of a mixed layer.

Q in the formula (2′) is also preferably a hydroxy group or the following formula (3′) from the viewpoint of having polarity and suppressing the formation of a mixed layer.

In the formulae (2) and (2′), each Z¹ independently represents a hydrogen atom or an alkyl group having 1 or more and 4 or less carbon atoms, at least one of which is preferably an alkyl group having 1 or more and 4 or less carbon atoms. In the formulae (2) and (2′), it is more preferred that two or more of Z¹ are alkyl groups having 1 or more and 4 or less carbon atoms, it is even more preferred that four or more of Z¹ are alkyl groups having 1 or more and 4 or less carbon atoms, and it is particularly preferred that all of Z¹ are alkyl groups having 1 or more and 4 or less carbon atoms. The more Z¹ is an alkyl group having 1 or more and 4 or less carbon atoms, the better the gas resistance, because acidic gases such as ozone are sterically inhibited from approaching the unreacted carbon-carbon double bond to which Z¹ is bonded.

When Z¹ in the formulae (2) and (2′) is an alkyl group having 1 or more and 4 or less carbon atoms, the number of carbon atoms in the alkyl group is preferably 1 or more and 3 or less, more preferably 1 or more and 2 or less, and even more preferably 1, i.e., a methyl group.

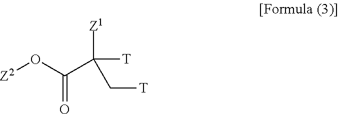

In the formula (3), Z¹ represents a hydrogen atom or an alkyl group having 1 or more and 4 or less carbon atoms, and Z² represents a bonding hand with R in the formula (1) or (2). T represents a bonding hand with arbitrary atoms.

When Z¹ in the formula (3) is an alkyl group having 1 or more and 4 or less carbon atoms, the number of carbon atoms in the alkyl group is preferably 1 or more and 3 or less, more preferably 1 or more and 2 or less, and even more preferably 1, i.e., a methyl group.

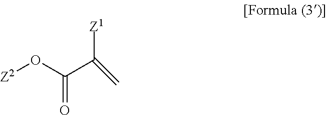

In the formula (3′), Z¹ represents a hydrogen atom or an alkyl group having 1 or more and 4 or less carbon atoms, and Z² represents a bonding hand with R in the formula (1′) or (2′).

When Z¹ in the formula (3′) is an alkyl group having 1 or more and 4 or less carbon atoms, the number of carbon atoms in the alkyl group is preferably 1 or more and 3 or less, more preferably 1 or more and 2 or less, and even more preferably 1, i.e., a methyl group.

The present protective layer of the present electrophotographic photoconductor is preferably a layer containing a polymer having a group represented by the following R′, a structure represented by the following formula (5), and a structure represented by the following formula (6).

R′ represents a divalent group selected from an alkylene group having 1 or more and 8 or less carbon atoms, an oxyalkylene group having 1 or more and 8 or less carbon atoms, and —O—(C═O)—(CH₂)ₚ— (where p is 2 or more and 6 or less).

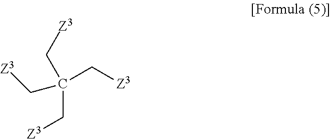

In the formula (5), Z³ represents a bonding hand with arbitrary atoms.

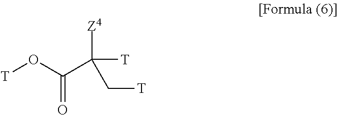

In the formula (6), Z⁴ represents an alkyl group having 1 or more and 4 or less carbon atoms. T represents a bonding hand with arbitrary atoms.

### [R′]

The group represented by R′ is a divalent group selected from an alkylene group having 1 or more and 8 or less carbon atoms, an oxyalkylene group having 1 or more and 8 or less carbon atoms, and —O—(C═O)—(CH₂)ₚ— (where p is 2 or more and 6 or less). Preferred embodiments of these are the same as those of the connecting chains R in the formula (1), (2), (1′), or (2′) described above.

### [Formulae (5) and (6)]

In the formula (5), Z³ represents a bonding hand with arbitrary atoms. For example, carbon, hydrogen, nitrogen, and oxygen are assumed as the arbitrary atoms.

In the formula (6), Z⁴ represents an alkyl group having 1 or more and 4 or less carbon atoms. T represents a bonding hand with arbitrary atoms. For example, carbon, hydrogen, nitrogen, and oxygen are assumed as the arbitrary atoms.

When Z⁴ in the formula (6) is an alkyl group having 1 or more and 4 or less carbon atoms, the number of carbon atoms in the alkyl group is preferably 1 or more and 3 or less, more preferably 1 or more and 2 or less, and even more preferably 1, i.e., a methyl group.

Whether or not the protective layer of the electrophotographic photoconductor is a layer containing a polymer having the group represented by R′, the structure represented by the formula (5), and the structure represented by the formula (6) can be checked, for example, by the following method.

The protective layer portion is isolated from the electrophotographic photoconductor, and the structure contained in the protective layer can be analyzed by pyrolysis GC/MS analysis to detect the group represented by R′, the structure represented by the formula (5), and the structure represented by the formula (6).

When the protective layer has the structure represented by the formula (5), examples of the compound that can be detected by pyrolysis GC/MS analysis include pentaerythritol, methylpentaerythritol, dimethylpentaerythritol, trimethylpentaerythritol, tetramethylpentaerythritol, ethylpentaerythritol, diethylpentaerythritol, triethylpentaerythritol, tetraethylpentaerythritol, and dipentaerythritol.

When the protective layer has the structure represented by the formula (6), examples of the compound contained in the protective layer before curing (before polymerization) include acrylic acid, methacrylic acid, 2-ethylprop-2-enoic acid, 2-propylprop-2-enoic acid, 2-butylprop-2-enoic acid, methyl acrylate, methyl methacrylate, methyl 2-ethylprop-2-enoic acid, methyl 2-propylprop-2-enoic acid, methyl 2-butylprop-2-enoic acid, ethyl acrylate, ethyl methacrylate, ethyl 2-ethylprop-2-enoic acid, ethyl 2-propylprop-2-enoic acid, and ethyl 2-butylprop-2-enoic acid.

These compounds contained in the protective layer before curing (before polymerization) may remain in the protective layer after curing as unreacted compounds. In this case, the protective layer after curing is subjected to pyrolysis GC/MS analysis to detect the unreacted compound, so that the protective layer can be assumed to be a layer containing a polymer having the structure represented by the formula (6).

### [Molecular Weight]

The compound a having a structure represented by the formula (1′) and the compound b having a structure represented by the formula (2′) preferably each have a molecular weight of 400 to 1,400.

As described above, these compounds a and b do not have a side chain with low polarity as in the alkyl group, and have a structure in which groups with relatively high polarity C═O bonds (such as acryloyl and methacryloyl groups) or hydroxy groups are located on the outside of the molecule. Therefore, it is considered that, even if the molecular weight is small, a mixed layer is unlikely to form. However, if the molecular weight is too small, the effect of suppressing mixing may be relatively low. On the other hand, if the molecular weight of each of the compounds a and b is large, it is generally considered that a mixed layer is unlikely to form.

From such a viewpoint, the molecular weight of each of the compounds a and b is preferably 400 or more, more preferably 500 or more, and particularly preferably 550 or more. In addition, it is preferably 1,400 or less, more preferably 1,200 or less, and particularly preferably 1,000 or less.

### [Functional Group Equivalent]

As for the compound a represented by the formula (1′) or the compound b represented by the formula (2′), the molecular weight X of the compound a or the compound b and the number Y of acryloyl and methacryloyl groups in one molecule preferably satisfy the following formula (4).

$$120 \leq X / Y \leq 400 \qquad ( 4 )$$

If the number of polar (meth)acryloyl or hydroxyl groups is large, the mixing suppression effect of the aforementioned polar groups is enhanced, and the formation of a mixed layer can be further suppressed. In other words, by having a sufficient number of polar groups (acryloyl or methacryloyl groups) relative to the molecular weight, the formation of a mixed layer can be further suppressed. In addition, sufficient mechanical strength can be achieved to provide abrasion resistance.

From such a viewpoint, in the compound a or b represented by the formula (1′) or (2′), the ratio (X/Y) of the molecular weight X of the compound a or b to the number Y of acryloyl and methacryloyl groups in one molecule, i.e., the functional group equivalent, is preferably 400 or less, more preferably 300 or less, even more preferably 200 or less, and still more preferably 180 or less.

In addition, since the residual stress is considered to be low and cracking is unlikely to occur when the ratio (X/Y), i.e., the functional group equivalent, is high, the ratio (X/Y), i.e., the functional group equivalent, is preferably 120 or more, more preferably 130 or more, even more preferably 140 or more, and still more preferably 150 or more.

The number Y of acryloyl and methacryloyl groups in one molecule is preferably 2 or more, more preferably 3 or more, and even more preferably 4 or more. In addition, it is preferably 12 or less, more preferably 10 or less, even more preferably 8 or less, and particularly preferably 6 or less.

### (Metal Oxide Particles)

The present protective layer preferably contains metal oxide particles from the viewpoint of imparting charge transport capability and improving the mechanical strength.

The metal oxide particles used may be metal oxide particles that can be used in electrophotographic photoconductors.

Examples of the metal oxide particles include metal oxide particles containing one type of metal element, such as titanium oxide, tin oxide, aluminum oxide, silicon oxide, zirconium oxide, zinc oxide, or iron oxide, and metal oxide particles containing multiple types of metal elements, such as calcium titanate, strontium titanate, and barium titanate. Only one type of the metal oxide particles may be used, or a mixture of multiple types of the particles may be used.

Among these metal oxide particles, titanium oxide, tin oxide, aluminum oxide, silicon oxide, and zinc oxide are preferred, and titanium oxide and tin oxide are more preferred. Titanium oxide is particularly preferred.

The crystal type of the titanium oxide particles may be any of rutile, anatase, brookite, and amorphous. Among the titanium oxide particles having these different crystal states, the one having multiple crystal states may be contained.

The surface of the metal oxide particles may be subjected to various surface treatments. For example, the surface thereof may be treated with an inorganic compound such as tin oxide, aluminum oxide, antimony oxide, zirconium oxide, or silicon oxide, or with an organic compound such as stearic acid, a polyol, or an organic silicon compound. In particular, when titanium oxide particles are used, the surface thereof is preferably treated with an organic silicon compound.

Examples of the organic silicon compound include silicone oils such as dimethylpolysiloxane, organosilanes such as methyldimethoxysilane, silazanes such as hexamethyldisilazane, and silane coupling agents such as 3-methacryloyloxypropyltrimethoxysilane, 3-acryloyloxypropyltrimethoxysilane, vinyltrimethoxysilane, γ-mercaptopropyltrimethoxysilane, and γ-aminopropyltriethoxysilane. In particular, 3-methacryloyloxypropyltrimethoxysilane, 3-acryloyloxypropyltrimethoxysilane, and vinyltrimethoxysilane each having a chain-polymerizable functional group are preferred from the viewpoint of improving the mechanical strength of the present protective layer.

The outermost surface of the surface-treated particles may be treated with a treatment agent such as aluminum oxide, silicon oxide, or zirconium oxide before being treated with the aforementioned treating agent.

The metal oxide particles preferably have an average primary particle diameter of 500 nm or less, more preferably 100 nm or less, and even more preferably 50 nm or less; and more preferably 1 nm or more, and even more preferably 5 nm or more.

The average primary particle diameter can be obtained based on an arithmetic average value of particle diameters directly observed using a transmission electron microscope (hereinafter also referred to as TEM).

The content of the metal oxide particles in the present protective layer is preferably 20 parts by mass or more, more preferably 60 parts by mass or more, and even more preferably 80 parts by mass or more, relative to 100 parts by mass of the polymer contained in the present protective layer, from the viewpoint of electrical characteristics. In addition, it is preferably 200 parts by mass or less, more preferably 160 parts by mass or less, and even more preferably 120 parts by mass or less, from the viewpoint of maintaining the charge on the surface.

### (Other Materials)

The present protective layer may contain, in addition to the above-mentioned materials, other materials as necessary. For example, the present protective layer may contain a “charge transport material” from the viewpoint of improving the charge transport capability and a “polymerization initiator” for promoting the polymerization reaction, as the other materials. It may further contain other materials such as stabilizers (such as a heat stabilizer, an ultraviolet absorber, a light stabilizer, and an antioxidant), a dispersant, an antistatic agent, a colorant, and a lubricant, as necessary. These materials may be appropriately used alone or in any combination of two or more types thereof in any ratio.

### [Charge Transport Material]

The charge transport material contained in the present protective layer can be the same as the charge transport material used in the present photosensitive layer described below.

The protective layer may have a structure in which a charge transport material having a chain-polymerizable functional group is polymerized, from the viewpoint of improving the Martens hardness on the surface of the photoconductor.

Examples of the chain-polymerizable functional group of the charge transport material having a chain-polymerizable functional group include an acryloyl group, a methacryloyl group, a vinyl group, and an epoxy group. Among them, an acryloyl group or a methacryloyl group is preferred from the viewpoint of curability. The structure of the charge transport material portion of the charge transport material having a chain-polymerizable functional group is preferably a carbazole derivative, an arylamine derivative, a stilbene derivative, a butadiene derivative, or an enamine derivative, and a structure obtained by bonding multiple types of these compounds.

The content of the charge transport material in the protective layer of the present electrophotographic photoconductor is not particularly limited. The content thereof is preferably 10 parts by mass or more, more preferably 30 parts by mass or more, and even more preferably 50 parts by mass or more, relative to 100 parts by mass of a polymer having a structure represented by the formula (1) or (2), a polymer of a compound having a structure represented by the formula (1′) or (2′), or a polymer having a group represented by R′, a structure represented by the formula (5), and a structure represented by the formula (6), from the viewpoint of electrical characteristics. In addition, it is preferably 300 parts by mass or less, more preferably 200 parts by mass or less, and even more preferably 150 parts by mass or less, from the viewpoint of maintaining good surface resistance.

### [Polymerization Initiator]

Examples of the polymerization initiator include a thermal polymerization initiator and a photopolymerization initiator.

Examples of the thermal polymerization initiator include peroxide-based compounds such as 2,5-dimethylhexane-2,5-dihydroperoxide, and azo-based compounds such as 2,2′-azobis(isobutyronitrile).

The photopolymerization initiator can be classified into a direct cleavage type and a hydrogen abstraction type based on a difference in a radical generation mechanism.

Examples of the direct cleavage type photopolymerization initiator include: acetophenone-based or ketal-based compounds such as acetophenone, 2-benzoyl-2-propanol, 1-benzoylcyclohexanol, 2,2-diethoxyacetophenone, benzyl dimethyl ketal, and 2-methyl-4′-(methylthio)-2-morpholinopropiophenone; benzoin ether-based compounds such as benzoin, benzoin methyl ether, benzoin ethyl ether, benzoin isobutyl ether, benzoin isopropyl ether, and 0-tosylbenzoin; and acylphosphine oxide-based compounds such as diphenyl(2,4,6-trimethylbenzoyl) phosphine oxide, phenylbis(2,4,6-trimethylbenzoyl)phosphine oxide, and lithium phenyl(2,4,6-trimethylbenzoyl)phosphonate.

Examples of the hydrogen abstraction type photopolymerization initiator include: benzophenone-based compounds such as benzophenone, 4-benzoylbenzoic acid, 2-benzoylbenzoic acid, methyl 2-benzoylbenzoate, methyl benzoylformate, benzyl, p-anisyl, 2-benzoylnaphthalene, 4,4′-bis(dimethylamino)benzophenone, 4,4′-dichlorobenzophenone, and 1,4-dibenzoylbenzene; and anthraquinone-based or thioxanthone-based compounds such as 2-ethylanthraquinone, 2-isopropylthioxanthone, 2-chlorothioxanthone, 2,4-dimethylthioxanthone, 2,4-diethylthioxanthone, and 2,4-dichlorothioxanthone. Examples of other photopolymerization initiators include camphorquinone, 1-phenyl-1,2-propanedione-2-(o-ethoxycarbonyl)oxime, acridine-based compounds, triazine-based compounds, and imidazole-based compounds.

The photopolymerization initiator preferably has an absorption wavelength in a wavelength region of a light source used for light irradiation in order to efficiently absorb light energy to generate a radical.

From the viewpoint of preventing a decrease in radical generation efficiency, it is preferable to include an acylphosphine oxide-based compound having an absorption wavelength in a relatively longer wavelength range among the photopolymerization initiators.

In this case, the use of an acylphosphine oxide-based compound in combination with a hydrogen abstraction type photopolymerization initiator is more preferable from the viewpoint of complementing the curability on the surface of the protective layer. The content ratio of the hydrogen abstraction type initiator to the acylphosphine oxide-based compound is not particularly limited. For example, it is preferable to contain 0.1 part by mass or more of the hydrogen abstraction type initiator relative to 1 part by mass of the acylphosphine oxide-based compound from the viewpoint of complementing the curability on the surface, and it is preferable to contain 5 parts by mass or less thereof from the viewpoint of maintaining the internal curability.

Materials having a photopolymerization promoting effect can be used alone or in combination with the above-mentioned photopolymerization initiator. Examples of the materials having a photopolymerization promoting effect include triethanolamine, methyldiethanolamine, ethyl 4-dimethylaminobenzoate, isoamyl 4-dimethylaminobenzoate, (2-dimethylamino)ethyl benzoate, and 4,4′-dimethylaminobenzophenone.

The polymerization initiator may be used alone or in a mixture of two or more types. The content of the polymerization initiator is preferably 0.5 to 40 parts by mass, more preferably 1 part by mass or more or 20 parts by mass or less, relative to 100 parts by mass of the total radical-polymerizable content.

### (Method for Forming Present Protective Layer)

The following describes a method for forming the present protective layer.

The method for forming the present protective layer is not particularly limited. For example, the present protective layer can be formed by coating a coating liquid in which a compound a having a structure represented by the formula (1′) or a compound b having a structure represented by the formula (2′), optionally the metal oxide particles, optionally the polymerization initiator, optionally the charge transport material, and optionally other materials are dissolved in a solvent, or a coating liquid in which the materials are dispersed in a dispersion medium (referred to as “the present protective layer-forming coating liquid”) onto the present photosensitive layer, and then curing the coating liquid.

### [Solvent Used in Protective Layer-Forming Coating Liquid]

Examples of the organic solvent used in the present protective layer-forming coating liquid include: alcohols such as methanol, ethanol, propanol, and 2-methoxyethanol; ethers such as tetrahydrofuran; esters such as methyl formate; ketones such as acetone; aromatic hydrocarbons such as benzene and toluene; chlorinated hydrocarbons such as dichloromethane and chloroform; nitrogen-containing compounds such as n-butylamine; and aprotic polar solvents such as acetonitrile. Among them, a mixed solvent in any combination and in any ratio can also be used. Even an organic solvent that alone does not dissolve materials for the protective layer of the present electrophotographic photoconductor can be used if it can be dissolved, for example, by mixing with the above-mentioned organic solvent. In general, the use of a mixed solvent reduces coating unevenness. When an immersion coating method is used in the coating method described below, it is preferable to select a solvent that does not dissolve the underlying layer. From this point of view, it is preferable to contain alcohols having low solubility in polycarbonate and polyarylate, which are suitably used in the photosensitive layer.

The amount ratio of the organic solvent used in the present protective layer-forming coating liquid to the solid content differs depending on the coating method of the protective layer-forming coating liquid, and may be changed and used as appropriate so as to form a uniform coating film in the coating method to be applied.

### [Coating Method]

The method for coating a coating liquid for forming the present protective layer is not particularly limited, and examples thereof include a spray coating method, a spiral coating method, a ring coating method, and an immersion coating method.

The above coating method is performed to form a coating film, and the coating film is then dried. The temperature and time of drying may be any as long as necessary and sufficient drying can be achieved. However, if the protective layer is formed only by air-drying after the photosensitive layer coating, it is preferable to perform sufficient drying by the method described in the method for forming a photosensitive layer described below.

### [Method for Curing Present Protective Layer]

The present protective layer can be formed by coating the present protective layer-forming coating liquid, and then curing the coating liquid by applying external energy. Examples of the external energy used in the curing include heat, light, and radiation.

By such a reaction during curing, the compound a represented by the formula (1′) is polymerized to form a polymer A or A′, and the compound b represented by the formula (2′) is polymerized to form a polymer B or B′.

Examples of the method for applying heat energy include heating methods using gases such as air and nitrogen, steam, various heat media, infrared rays, and electromagnetic waves. The heating can be applied from the coated surface side or the support side. The heating temperature is preferably 100° C. or higher and 170° C. or lower.

As for the light energy, an ultraviolet (UV) irradiation light source having a light emission wavelength mainly in UV light, such as a high-pressure mercury lamp, a metal halide lamp, an electrodeless lamp bulb, or a light emitting diode, can be used. In addition, a visible light source can also be selected according to an absorption wavelength of the chain-polymerizable compound or the photopolymerization initiator.

The amount of light irradiation is preferably 10 J/cm² or more, more preferably 30 J/cm² or more, and particularly preferably 100 J/cm² or more, from the viewpoint of curability. In addition, it is preferably 500 J/cm² or less, more preferably 300 J/cm² or less, and particularly preferably 200 J/cm² or less, from the viewpoint of electrical characteristics.

Examples of the radiation energy include those using an electron beam (EB).

Among these energies, those using the light energy are preferred from the viewpoint ease of reaction rate control, simplicity of apparatus, and length of pot life.

After the protective layer is cured, a heating step may be added from the viewpoint of alleviating residual stress, alleviating residual radicals, and improving electrical characteristics. The heating temperature is preferably 60° C. or higher, more preferably 100° C. or higher; and preferably 200° C. or lower, more preferably 150° C. or lower.

### (Layer Thickness)

The thickness of the present protective layer is preferably 0.5 μm or more, more preferably 1 μm or more, from the viewpoint of abrasion resistance. In addition, it is preferably 5 μm or less, more preferably 3 μm or less, from the viewpoint of electrical characteristics.

From the same viewpoint, the thickness of the present protective layer is preferably 1/50 or more relative to the thickness of the present photosensitive layer, more preferably 1/40 or more, and even more preferably 1/30 or more. In addition, it is preferably ⅕ or less, more preferably 1/10 or less, and even more preferably 1/20 or less.

### <Present Photosensitive Layer>

The photosensitive layer (also referred to as “the present photosensitive layer”) in the present electrophotographic photoconductor may be a layer containing at least a charge generation material (CGM) and a charge transport material.

The present photosensitive layer may be a single-layer type photosensitive layer containing a charge generation material and a charge transport material in the same layer, or a multi-layer type photosensitive layer in which a charge generation layer and a charge transport layer are separated.

Regardless of whether it is a single-layer type photosensitive layer or a multi-layer type photosensitive layer, if a mixed layer is formed between the protective layer and the photosensitive layer, the same mechanism occurs where the concentration of the charge transport material in the mixed layer is lower than in the photosensitive layer, resulting in a decrease in the charge transport capacity. Therefore, the effects of the present invention can be enjoyed regardless of whether the photosensitive layer is a single-layer type photosensitive layer or a multi-layer type photosensitive layer. However, since the single-layer type photosensitive layer generally has a hole transport material, an electron transport material, a charge generation material, and a binder resin in the same layer, the single-layer type photosensitive layer has a high proportion of low molecular weight components, and a lower glass transition temperature than that of the multi-layer type photosensitive layer. It is then considered that, since the photosensitive layer is easily softened by the heat generated during heating and drying or curing during the formation of the protective layer, the single-layer type photosensitive layer is easier to form a mixed layer than the multi-layer type photosensitive layer. From such a viewpoint, it is considered that the effects of the present invention can be enjoyed more in the single-layer type photosensitive layer than in the multi-layer type photosensitive layer.

### <Single-Layer Type Photosensitive Layer>

The present photosensitive layer, when it is a single-layer type photosensitive layer, preferably contains at least a charge generation material (CGM), a hole transport material (HTM), an electron transport material (ETM), and a binder resin in the same layer.

### (Charge Generation Material)

Examples of the charge generation material used in the present photosensitive layer include various photoconductive materials such as inorganic photoconductive materials and organic pigments. Among them, organic pigments are particularly preferred, and a phthalocyanine pigment and an azo pigment are more preferred.

Specifically, when a phthalocyanine pigment is used as the charge generating material, metal-free phthalocyanines and phthalocyanines coordinated with a metal such as copper, indium, gallium, tin, titanium, zinc, vanadium, silicon or germanium, or an oxide or halide thereof, are used. Examples of ligands for trivalent or higher metal atoms include hydroxy groups and alkoxy groups in addition to the oxygen atoms and the chlorine atoms. Among them, X-type and i-type metal-free phthalocyanines, A-type, B-type, and D-type titanyl phthalocyanines, vanadyl phthalocyanines, chloroindium phthalocyanines, chlorogallium phthalocyanines, and hydroxygallium phthalocyanines, which have high sensitivity, are particularly suitable.

When an azo pigment is used, various known bisazo pigments and trisazo pigments are suitably used.

The charge generation material may be used alone or in any combination of two or more types thereof in any ratio. When two or more charge generation materials are used together, the charge generation materials to be used together may each be mixed afterwards, or they may be mixed together during the production and processing steps of the charge generation materials, such as synthesis, pigmentation, and crystallization.

The charge generation material preferably has a small particle diameter from the viewpoint of electrical characteristics. Specifically, the particle diameter of the charge generation material is preferably 1 μm or less, more preferably 0.5 μm or less. The lower limit thereof is 0.01 μm or more. The particle diameter of the charge generation material refers to a particle diameter in the state contained in the photosensitive layer.

The amount of the charge generation material in the single-layer type photosensitive layer is preferably 0.1% by mass or more, more preferably 0.5% by mass or more, from the viewpoint of sensitivity. In addition, it is preferably 50% by mass or less, more preferably 20% by mass or less, from the viewpoint of sensitivity and chargeability.

### (Charge Transport Material)

The charge transport material is classified into a hole transport material mainly having hole transport ability and an electron transport material mainly having electron transport ability. The present photosensitive layer, when it is a single-layer type photosensitive layer, preferably contains at least a hole transport material and an electron transport material in the same layer.

### [Hole Transport Material]

The hole transport material (HTM) can be selected from known materials. Examples thereof include electron-donating materials, such as heterocyclic compounds such as a carbazole derivative, an indole derivative, an imidazole derivative, an oxazole derivative, a pyrazole derivative, a thiadiazole derivative, and a benzofuran derivative, an aniline derivative, a hydrazone derivative, an arylamine derivative, a stilbene derivative, a butadiene derivative, and an enamine derivative, a compound obtained by bonding a plurality of these compounds, and a polymer having a group derived from these compounds in a main chain or a side chain.

Among them, a carbazole derivative, an arylamine derivative, a stilbene derivative, a butadiene derivative, an enamine derivative, and a compound obtained by bonding a plurality of these compounds are preferred, and an arylamine derivative and an enamine derivative are more preferred.

The molecular weight of the hole transport material is preferably 600 or more, more preferably 650 or more, even more preferably 700 or more, and particularly preferably 740 or more, from the viewpoint of electrical characteristics. In addition, it is preferably 1,200 or less, more preferably 1,000 or less, and even more preferably 900 or less, from the viewpoint of ease of synthesis and stability of the compound.

The hole transport material may be used alone or in any combination of two or more types thereof in any ratio.

Preferred examples of the structure of the hole transport material are shown below.

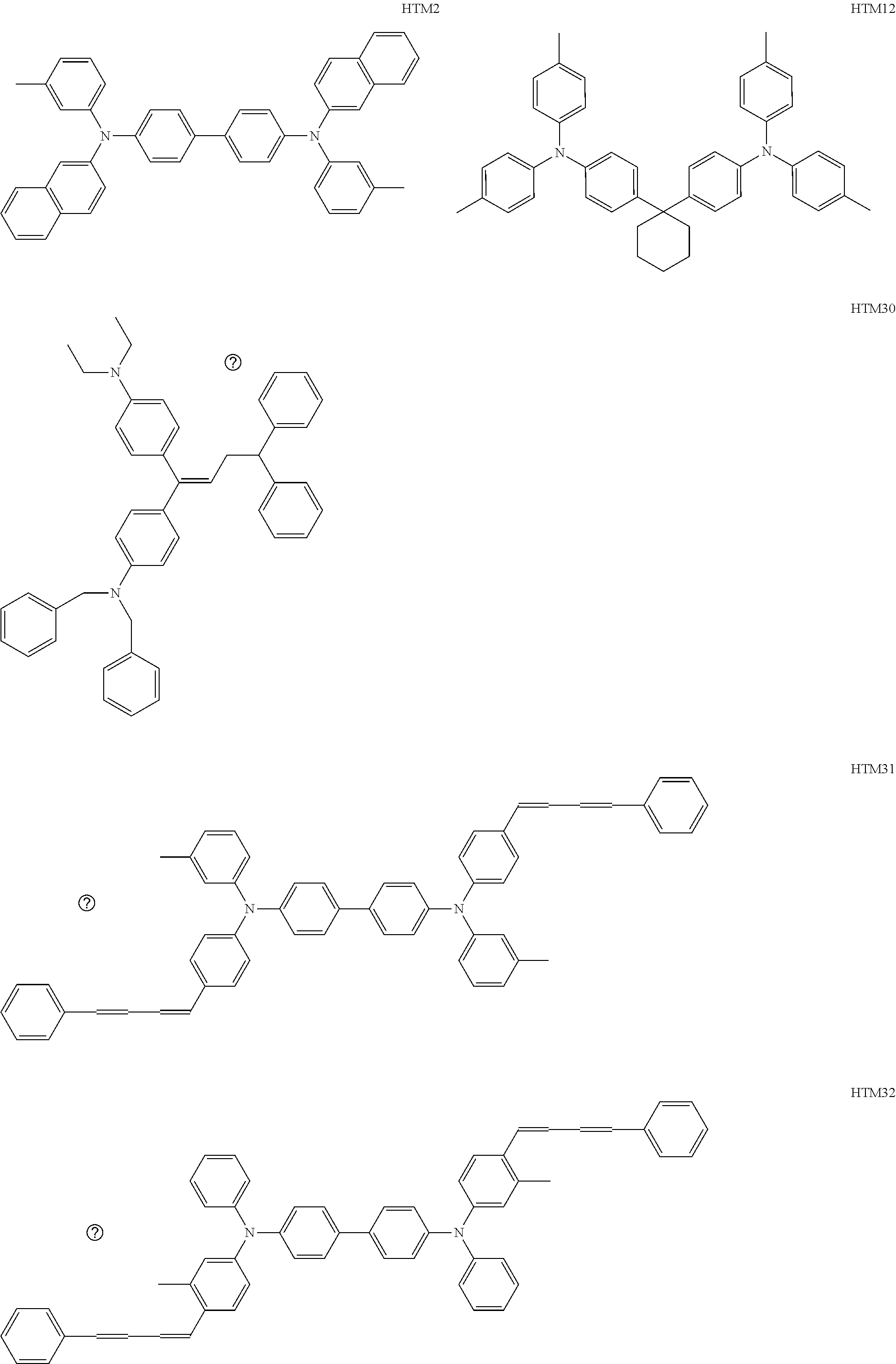

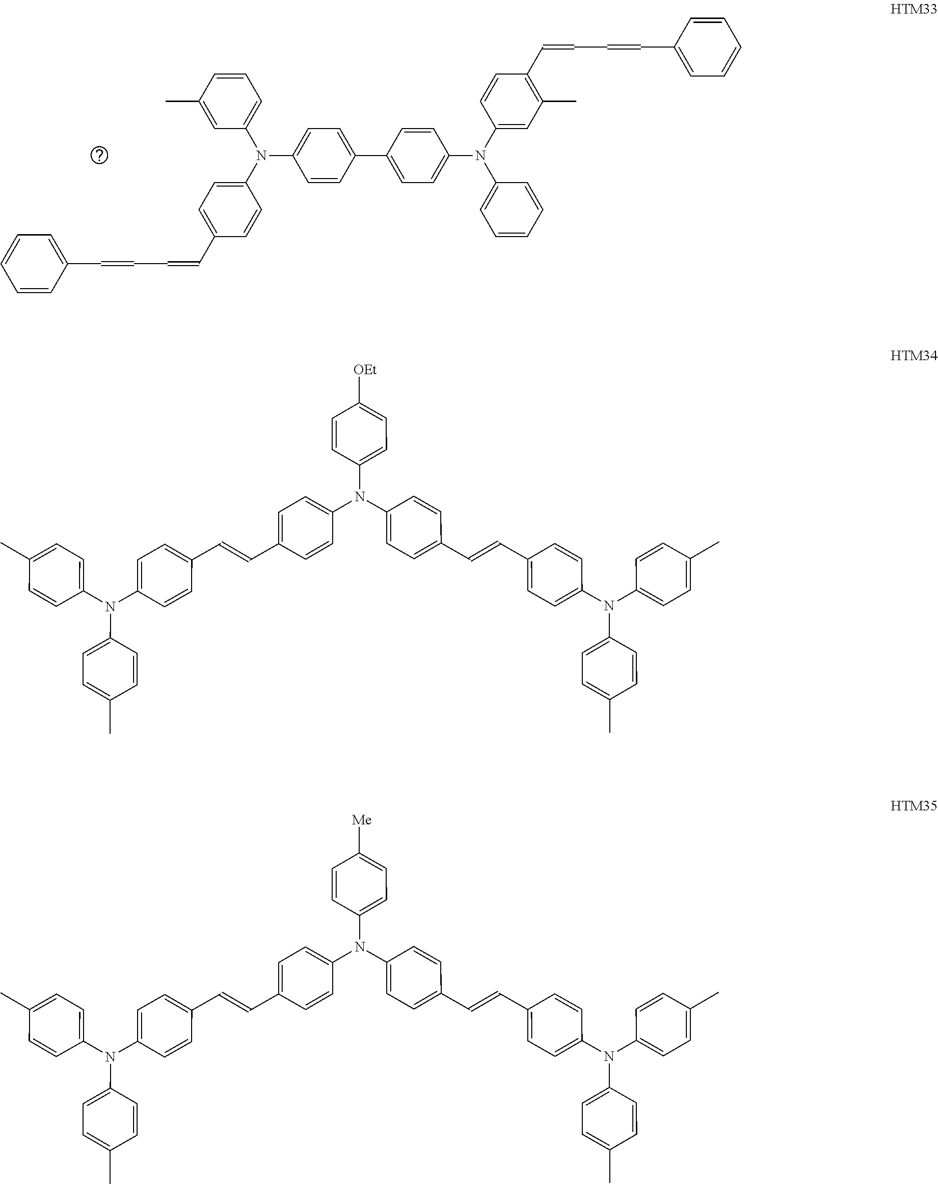

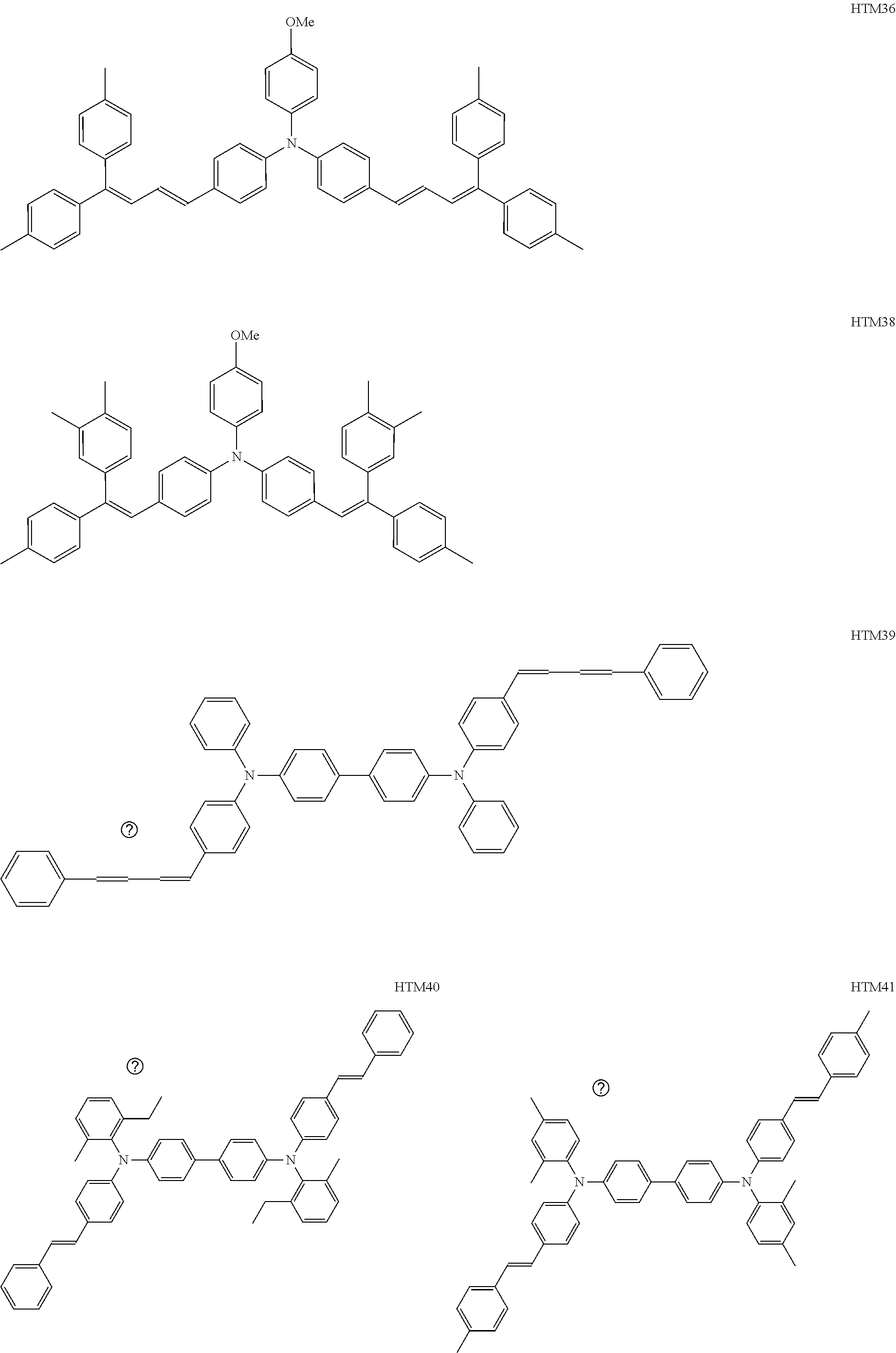

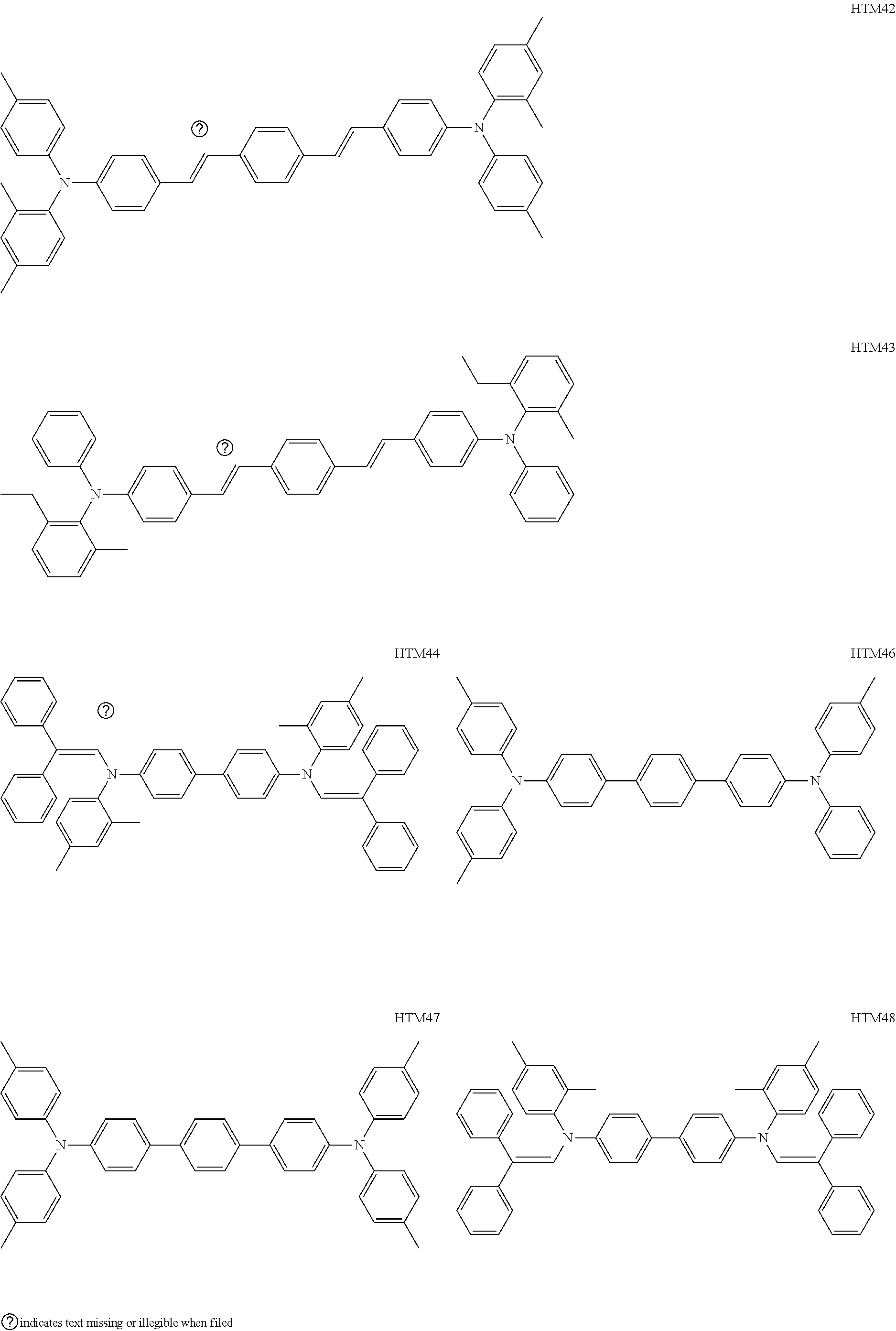

Among the above hole transport materials, HTM31, HTM32, HTM33, HTM34, HTM35, HTM39, HTM40, HTM41, HTM42, HTM43, and HTM48 are preferred; and HTM39, HTM40, HTM41, HTM42, HTM43, and HTM48 are more preferred, from the viewpoint of electrical characteristics.

### [Electron Transport Material]

The electron transport material (ETM) can be selected from known materials. Examples thereof include: electron-attracting materials, such as aromatic nitro compounds such as 2,4,7-trinitrofluorenone, cyano compounds such as tetracyanoquinodimethane, and quinone compounds such as diphenoquinone; and known cyclic ketone compounds and perylene pigments (perylene derivatives). Among them, quinone compounds and perylene pigments (perylene derivatives) are preferred, and quinone compounds are more preferred, from the viewpoint of electrical characteristics.

Among the quinone compounds, diphenoquinone and dinaphthylquinone are preferred from the viewpoint of electrical characteristics. Among them, dinaphthylquinone is more preferred.

The molecular weight of the electron transport material is preferably 400 or more, more preferably 410 or more, and even more preferably 420 or more, from the viewpoint of electrical characteristics. In addition, it is preferably 1,000 or less, more preferably 800 or less, and even more preferably 600 or less.

The electron transport material may be used alone or in any combination of two or more types thereof in any ratio.

Preferred examples of the structure of the electron transport material are shown below.

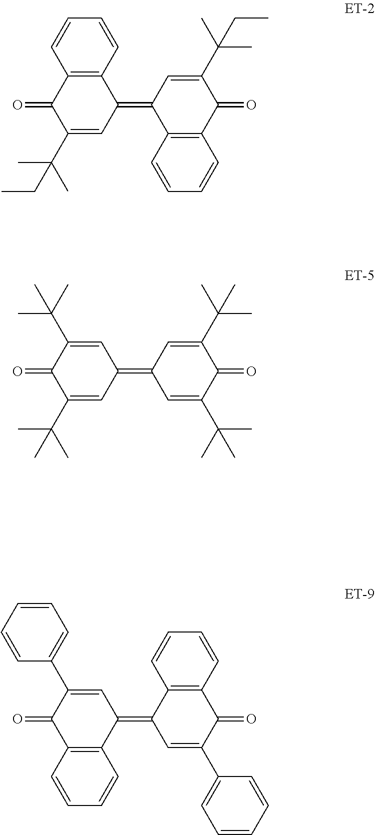 [SMILES: CCC(C)(C)C1=C/C(=C2/C=C(C(C)(C)CC)C(=O)c3ccccc32)c2ccccc2C1=O ; CC(C)(C)C1=CC(=C2C=C(C(C)(C)C)C(=O)C(C(C)(C)C)=C2)C=C(C(C)(C)C)C1=O ; O=C1C(c2ccccc2)=C/C(=C2/C=C(c3ccccc3)C(=O)c3ccccc32)c2ccccc21]

Among the above electron transport materials, ET-2 and ET-5 are preferred, and ET-2 is more preferred, from the viewpoint of electrical characteristics.

### [Contents of Hole Transport Material and Electron Transport Material]

The ratio of the content mass of the electron transport material to the content mass of the hole transport material in the single-layer type photosensitive layer is preferably 0.3 or more from the viewpoint of electron transportability, and more preferably 0.4 or more from the viewpoint of electrical characteristics. In addition, it is preferably 1.0 or less from the viewpoint of hole transportability, more preferably 0.9 or less from the viewpoint of suppressing precipitation of the electron transport material, and even more preferably 0.8 or less from the viewpoint of adhesiveness.

The content of the hole transport material in the present electrophotographic photoconductor is preferably 50 parts by mass or more, more preferably 80 parts by mass or more, and even more preferably 90 parts by mass or more, relative to 100 parts by mass of the binder resin described below, from the viewpoint of hole transportability. In addition, the upper limit thereof is preferably 200 parts by mass or less, more preferably 150 parts by mass or less, from the viewpoint of suppressing precipitation.

### (Binder Resin)

The following describes a binder resin used in the present photosensitive layer.

Examples of the binder resin used in the present photosensitive layer include: vinyl polymers such as polymethyl methacrylate, polystyrene, and polyvinyl chloride, or copolymers thereof; vinyl alcohol resins; polyvinyl butyral resins; polyvinyl formal resins; partially modified polyvinyl acetal resins; polyarylate resins; polyamide resins; polyurethane resins; polycarbonate resins; polyester resins; polyester carbonate resins; polyimide resins; phenoxy resins; epoxy resins; silicone resins; and partially-crosslinked cured product thereof. The above resins may each be modified with a silicon reagent or the like. These may be used alone or in any combination of two or more types thereof in any ratio.

The binder resin used in the present photosensitive layer preferably contains one or two or more types of polymers obtained by interfacial polymerization.

As the binder resin obtained by interface polymerization, a polycarbonate resin and a polyester resin are preferred, a polycarbonate resin or a polyarylate resin is more preferred, and a polycarbonate resin is even more preferred. In addition, a polymer obtained by using an aromatic diol as a raw material is particularly preferred.

### (Other Materials)

The present photosensitive layer may contain, in addition to the above-mentioned materials, known additives such as an antioxidant, a plasticizer, an ultraviolet absorber, an electron attracting compound, a leveling agent, and a visible light shielding agent, for improving film formability, flexibility, coating ability, contamination resistance, gas resistance, light resistance, and the like. The present photosensitive layer may also contain various additives such as a sensitizer, a dye, a pigment (excluding the charge generation material, the hole transport material, and the electron transport material described above), and a surfactant, as necessary. Examples of the surfactant include silicone oil and fluorine compounds. In the present invention, these may be appropriately used alone or in any combination of two or more types thereof in any ratio.

For the purpose of reducing friction resistance on the surface of the photosensitive layer, the present photosensitive layer may contain a fluorine resin, a silicone resin, or the like, and may contain particles made of these resins or particles made of inorganic compounds such as aluminum oxide.

### (Layer Thickness)

When the present photosensitive layer is a single-layer type photosensitive layer, the thickness of the present photosensitive layer is preferably 20 μm or more, more preferably 25 μm or more, from the viewpoint of dielectric breakdown resistance. In addition, it is preferably 50 μm or less, more preferably 40 μm or less, from the viewpoint of electrical characteristics.

### <Multi-Layer Type Photosensitive Layer>

When the present electrophotographic photoconductor has a multi-layer type photosensitive layer, examples of the configuration thereof include a configuration in which a charge transport layer (CTL) containing an electron transport material (ETM) and a hole transport material (HTM) is laminated on a charge generation layer (CGL) containing a charge generation material (CGM). In this case, the multi-layer type photosensitive layer may also include any layer other than the charge generation layer (CGL) and the charge transport layer (CTL).

### <Charge Generation Layer (CGL)>

The charge generation layer generally contains a charge generation material (CGM) and a binder resin.

The charge generation material (CGM) and the binder resin are the same as in the single-layer type photosensitive layer described above.

### (Other Components)

The charge generation layer may contain other components in addition to the charge generation material and the binder resin, as necessary. For example, the charge generation layer may contain known additives such as an antioxidant, a plasticizer, an ultraviolet absorber, an electron attracting compound, a leveling agent, a visible light shielding agent, and a filler, for the purpose of improving film formability, flexibility, coating ability, contamination resistance, gas resistance, light resistance, and the like.

### (Blending Ratio)

In the charge generation layer, if the ratio of the charge generation material is too high, the stability of the coating liquid may be decreased due to aggregation and the like of the charge generation material, while if the ratio of the charge generation material is too low, the sensitivity of the photoconductor may be decreased. Therefore, as for the blending ratio (mass) of the binder resin and the charge generation material, the charge generation material is preferably contained in an amount of 10 parts by mass or more, more preferably 30 parts by mass or more, relative to 100 parts by mass of the binder resin; and preferably 1,000 parts by mass or less, more preferably 500 parts by mass or less, even more preferably 300 parts by mass or less from the viewpoint of film strength, and still more preferably 200 parts by mass or less.

### (Layer Thickness)

The thickness of the charge generation layer is preferably 0.1 μm or more, more preferably 0.15 μm or more. In addition, it is preferably 10 μm or less, more preferably 6 μm or less.

### <Charge Transport Layer (CTL)>

The charge transport layer (CTL) generally contains a hole transport material (HTM) and a binder resin, and may further contain an electron transport material (ETM).

The electron transport material (ETM), the hole transport material (HTM), and the binder resin are the same as in the single-layer type photosensitive layer described above.

As for the blending ratio of the binder resin and the hole transport material (HTM) in the charge transport layer (CTL), the hole transport material (HTM) is preferably contained in an amount of 20 parts by mass or more, more preferably 30 parts by mass or more from the viewpoint of reducing residual potential, and even more preferably 40 parts by mass or more from the viewpoint of stability in repeated use and degree of charge transfer, relative to 100 parts by mass of the binder resin. In addition, the hole transport material (HTM) is preferably contained in an amount of 200 parts by mass or less from the viewpoint of thermal stability of the photosensitive layer, more preferably 150 parts by mass or less from the viewpoint of compatibility of the hole transport material (HTM) and the binder resin, and even more preferably 120 parts by mass or less from the viewpoint of glass transition temperature, relative to 100 parts by mass of the binder resin.

### (Other Components)

The charge transport layer may contain other components in addition to the electron transport material (ETM), the hole transport material (HTM), and the binder resin, as necessary. For example, the charge transport layer may contain known additives such as an antioxidant, a plasticizer, an ultraviolet absorber, an electron attracting compound, a leveling agent, a visible light shielding agent, and a filler, for the purpose of improving film formability, flexibility, coating ability, contamination resistance, gas resistance, light resistance, and the like.

### (Layer Thickness)

The thickness of the charge transport layer is not particularly limited. It is preferably 5 μm or more and 50 μm or less, more preferably 10 μm or more or 35 μm or less, and even more preferably 15 μm or more or 25 μm or less, from the viewpoint of electrical characteristics, image stability, and high image resolution.

### <Method for Forming Photosensitive Layer>

In both the multi-layer and single-layer types, each of the layers can be formed as follows.

Materials to be contained are dissolved or dispersed in a solvent to obtain a coating liquid, the coating liquid is coated on a conductive support by a known method, such as immersion coating, spray coating, nozzle coating, bar coating, roll coating, or blade coating, and the coating and drying steps are sequentially repeated for each layer, thereby forming the layers.

However, it is not limited to this formation method.

The solvent or dispersion medium to be used for the preparation of the coating liquid is not particularly limited. Specific examples thereof include: alcohols such as methanol, ethanol, propanol, and 2-methoxyethanol; ethers such as tetrahydrofuran, 1,4-dioxane, and dimethoxyethane; aromatic hydrocarbons such as benzene, toluene, and xylene; and chlorinated hydrocarbons such as dichloromethane, chloroform, 1,2-dichloroethane, 1,1,2-trichloroethane, 1,1,1-trichloroethane, tetrachloroethane, 1,2-dichloropropane, and trichloroethylene. These may be used alone or in any combination of two or more types thereof in any type.

The amount of the solvent or dispersion medium used is not particularly limited. In view of the use purpose of each layer and properties of the solvent or dispersion medium selected, it is preferable to adjust the amount appropriately such that the physical properties of the coating liquid, such as solid content concentration and viscosity, are within the desired range.

As for the drying of the coating film, the coating film is preferably touch-dried at room temperature, and then heat-dried at a temperature range of generally 30° C. or higher and 200° C. or lower for 1 minute to 2 hours at a standstill or under air flow. The heating temperature may be constant, or the temperature may be varied during the heat drying.

### <Present Conductive Support>

The conductive support in the present electrophotographic photoconductor (also referred to as “the present conductive support”) is not particularly limited as long as it supports layers formed thereon and exhibits conductivity.

Examples of the present conductive support mainly used include: metal materials such as aluminum, aluminum alloy, stainless steel, copper, and nickel; resin materials with conductivity added by coexisting conductive powders of metal, carbon, and tin oxide; and resin, glass, and paper having conductive materials such as aluminum, nickel, and ITO (indium tin oxide alloy) vapor-deposited or coated on their surfaces.

The present conductive support used may be in the form of a drum, cylinder, sheet, belt, or the like.

The present conductive support may be a conductive support made of a metal material with a conductive material having a suitable resistance value coated thereon for controlling conductivity, surface properties, and the like, and for covering defects.

When a metal material such as an aluminum alloy is used as the present conductive support, the metal material may be coated with an anodic oxide film.

The average thickness of the anodic oxide film is preferably 20 μm or less, particularly preferably 7 μm or less.

The metal material, when coated with an anodic oxide film, is preferably subjected to a sealing treatment. The sealing treatment can be performed by a known method.

The surface of the present conductive support may be smooth or roughened by a special cutting method or polishing treatment. The surface may also be roughened by mixing particles having an appropriate particle diameter with the materials constituting the support.

In order to improve adhesion, blocking tendency, and the like, an undercoat layer described below may be provided between the present conductive support and the photosensitive layer.

### <Present Undercoat Layer>

The present electrophotographic photoconductor may include an undercoat layer (also referred to as “the present undercoat layer”) between the present photosensitive layer and the present conductive support.

Examples of the material used in the present undercoat layer include a resin and a resin having particles of organic pigments, metal oxides, or the like dispersed therein.

Examples of the organic pigments used in the undercoat layer include phthalocyanine pigments, azo pigments, and perylene pigments. In particular, phthalocyanine pigments and azo pigments, specifically the phthalocyanine pigment and the azo pigment as used as the charge generation material described above, can be exemplified.

Examples of the metal oxide particles used in the present undercoat layer include: metal oxide particles containing one metal element such as titanium oxide, aluminum oxide, silicon oxide, zirconium oxide, zinc oxide, or iron oxide; and metal oxide particles containing multiple metal elements such as calcium titanate, strontium titanate, and barium titanate. In the undercoat layer, only one type of particles may be used, or multiple types of particles may be used in mixture in any ratio and combination.

Among the above metal oxide particles, titanium oxide and aluminum oxide are preferred, and titanium oxide is particularly preferred. The titanium oxide particles, for example, may be surface-treated with an arbitrary inorganic or organic material. The crystal type of the titanium oxide particles may be any of rutile, anatase, brookite, and amorphous. The one having multiple crystal states may be contained.

The particle diameter of the metal oxide particles used in the present undercoat layer is not particularly limited. The average primary particle diameter is preferably 10 nm or more, and preferably 100 nm or less, more preferably 50 nm or less, from the viewpoint of the properties of the undercoat layer and the stability of the solution for forming the undercoat layer.

The binder resin used in the present undercoat layer can be selected and used, for example, from polyvinyl acetal resins such as polyvinyl butyral resin, polyvinyl formal resin, and partially acetalized polyvinyl butyral resin in which a part of butyral is modified with formal, acetal, or the like; and insulating resins such as polyarylate resin, polycarbonate resin, polyester resin, phenoxy resin, acrylic resin, methacrylic resin, polyamide resin, polyurethane resin, epoxy resin, silicone resin, polyvinyl alcohol resin, styrene-alkyd resin, silicone-alkyd resin, and phenol-formaldehyde resin. However, it is not limited to these polymers. These binder resins may be used alone or in a mixture of two or more types, or may be used in a cured form with a curing agent.

Among them, polyvinyl acetal resins, alcohol-soluble copolymerized polyamides, modified polyamides, and the like are preferred because of their good dispersibility and coating ability. Among them, alcohol-soluble copolymerized polyamides are particularly preferred.

The mixing ratio of the particles to the binder resin can be arbitrarily selected. The ratio is preferably in a range of 10% by mass to 500% by mass from the viewpoint of stability and coating ability of the dispersion.

The film thickness of the present undercoat layer can be arbitrarily selected. The film thickness is preferably 0.1 μm or more, and more preferably 20 μm or less, from the viewpoint of properties of the electrophotographic photoconductor and coating ability of the dispersion. The undercoat layer may contain a known antioxidant or the like.

### <Other Layers>

The present electrophotographic photoconductor may appropriately include other layers, as necessary, in addition to the present conductive support, the present photosensitive layer, the present protective layer, and the present undercoat layer described above.

### <Physical Properties of Present Electrophotographic Photoconductor>

The present electrophotographic photoconductor may have the following physical properties.

### (Martens Hardness)

The present electrophotographic photoconductor preferably has a Martens hardness of 230 N/mm² or more, more preferably 250 N/mm² or more, and even more preferably 290 N/mm² or more, from the viewpoint of providing sufficient abrasion resistance for practical use.

In the present invention, the Martens hardness of the photoconductor refers to a Martens hardness measured on the front surface side of the photoconductor.

The Martens hardness can be measured by the method described in Examples below.

### (Elastic Deformation Rate)

The present electrophotographic photoconductor preferably has an elastic deformation rate of 25% or more, more preferably 30% or more, and even more preferably 32% or more, from the viewpoint of providing sufficient abrasion resistance for practical use.

In the present invention, the elastic deformation rate of the photoconductor refers to an elastic deformation rate measured on the front surface side of the photoconductor.

The elastic deformation rate can be measured by the method described in Examples below.

### (Presence or Absence of Mixed Layer)

As described above, the present electrophotographic photoconductor is capable of suppressing the formation of a layer (mixed layer) of mixing of the components of the present protective layer and the present photosensitive layer between the two layers when forming the present protective layer, for example, when coating the protective layer-forming coating liquid on the surface of the photosensitive layer followed by heating and drying or by curing thereafter. Therefore, the present electrophotographic photoconductor can be configured without a mixed layer between the present protective layer and the present photosensitive layer. However, the absence of a mixed layer is not a requirement for the present electrophotographic photoconductor. This is because the effects of the present invention can be enjoyed without checking the presence or absence of the mixed layer.

Whether or not a mixed layer is formed between the protective layer and the photosensitive layer can be determined by morphologically observing the cross section of the photoconductor using an electron microscope or the like, and, if an intermediate layer is observed between the protective layer and the photosensitive layer, analyzing components of the intermediate layer using IR (infrared spectroscopy) or the like. When both the components of the protective layer and the photosensitive layer are detected, it can be determined that a mixed layer is formed.

### <<Present Image-Forming Apparatus>>

The present electrophotographic photoconductor can be used to configure an image-forming apparatus (also referred to as “the present image-forming apparatus”).

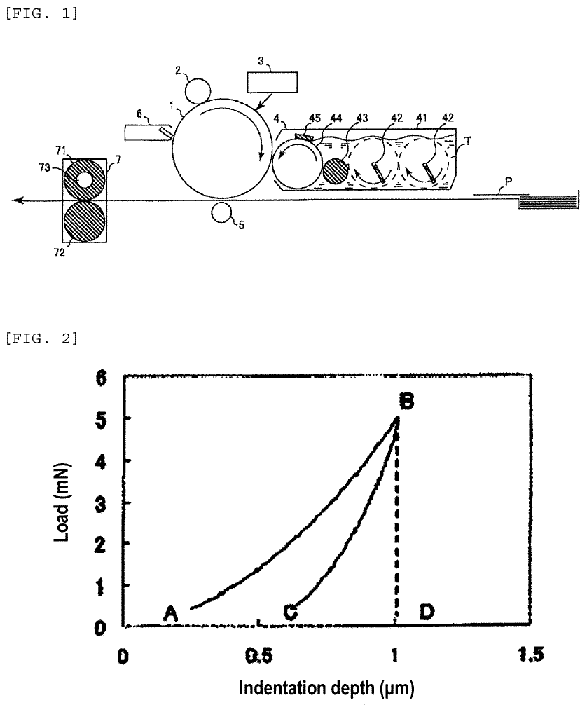

As shown in FIG. 1, the present image-forming apparatus includes a present electrophotographic photoconductor 1, a charging device 2, an exposing device 3, and a developing device 4, and may further include a transferring device 5, a cleaning device 6, and a fixing device 7, as necessary.

The present electrophotographic photoconductor 1 is not particularly limited as long as it is the present electrophotographic photoconductor described above. FIG. 1 shows, as one example thereof, a drum-shaped photoconductor including the photosensitive layer described above formed on the surface of a cylindrical conductive support. Along the outer peripheral surface of the present electrophotographic photoconductor 1, the charging device 2, the exposing device 3, the developing device 4, the transferring device 5, and the cleaning device 6 are disposed.

Examples of the charging device 2 include non-contact type corona charging devices such as corotron and scorotron, and contact type charging devices (direct type charging devices) that charge the photoconductor by bringing a voltage-applied charging member into contact with the surface of the photoconductor. Examples of the contact type charging devices include a charging roller and a charging brush. FIG. 1 shows a roller type charging device (charging roller) as one example of the charging device 2.

The type of the exposing device 3 is not particularly limited as long as the exposing device exposes the present electrophotographic photoconductor 1 to form an electrostatic latent image on the photosensitive surface of the present electrophotographic photoconductor 1.

The exposure may be performed by an internal exposure system of the photoconductor. The light used for exposure is arbitrary.

The type of a toner T is arbitrary, and may be a powder toner, a polymerized toner using a suspension polymerization method or an emulsion polymerization method, or the like.

The configuration of the developing device 4 is also arbitrary. The developing device 4 shown in FIG. 1 has a configuration in which the toner T is thinned by a regulating member (developing blade) 45, frictionally charged to a predetermined polarity, and brought into contact with the surface of the photoconductor 1 while being conveyed by being carried on a developing roller 44. However, it is not limited to this configuration.

The type of the transferring device 5 is not particularly limited, and may be a device using any method, such as an electrostatic transferring method such as corona transfer, roller transfer, or belt transfer, a pressure transferring method, or an adhesive transferring method.

The cleaning device 6 is not particularly limited.

For example, any cleaning device such as a brush cleaner or a blade cleaner can be used. If there is little or almost no toner remaining on the surface of the photoconductor, no cleaning device 6 may be used.

The configuration of the fixing device 7 is also arbitrary.

The image-forming apparatus may have a configuration capable of performing, for example, a static elimination step, in addition to the configurations described above.

In addition, the image-forming apparatus may have a configuration with further modifications, such as a configuration capable of performing steps such as a pre-exposure step and an auxiliary charging step, a configuration capable of performing offset printing, or a configuration of a full color tandem system using multiple toners.

### <<Present Electrophotographic Photoconductor Cartridge>>

The present electrophotographic photoconductor 1 can be used in combination with one or two or more of the charging device 2, the exposing device 3, the developing device 4, the transferring device 5, the cleaning device 6, and the fixing device 7, to thereby configure an integrated type cartridge (referred to as “the present electrophotographic photoconductor cartridge”).

The present electrophotographic photoconductor cartridge may have a configuration capable of being attached to or detached from an electrophotographic apparatus main body, such as a copier or a laser beam printer. In this case, for example, when the present electrophotographic photoconductor 1 or other members are deteriorated, the image-forming apparatus is capable of detaching the electrophotographic photoconductor cartridge from the image-forming apparatus main body and attaching another new electrophotographic photoconductor cartridge thereto, thereby facilitating maintenance and management of the image-forming apparatus.

### <<Explanation of Terms and Phrases>>

In the present invention, the expression “from X to Y” (wherein X and Y each represent an arbitrary numeral) encompasses the meaning “X or more and Y or less” and also encompasses the meaning “preferably more than X” or “preferably less than Y”, unless otherwise indicated.

The expression “X or more” (wherein X represents an arbitrary numeral) or “Y or less” (wherein Y represents an arbitrary numeral) encompasses the meaning “preferably more than X” or “preferably less than Y”.

### EXAMPLES

Embodiments of the present invention are further specifically described below with reference to Examples. However, the following Examples are shown for the purpose of explaining the present invention in detail and the present invention is not to be limited to the following Examples without departing from the gist thereof, and may be implemented with any modification. The term “parts” in the following Examples and Comparative Examples refers to “parts by mass” unless otherwise specified.

### (Preparation of Undercoat Layer-Forming Coating Liquid P1)

Twenty parts of D-type titanyl phthalocyanine showing a clear peak at a diffraction angle of 2θ=27.3°±0.2° in powder X-ray diffraction using CuKα rays, and 280 parts of 1,2-dimethoxyethane were mixed and ground for 2 hours using a sand grind mill for atomization dispersion treatment. To the mixture, 400 parts of a 1,2-dimethoxyethane solution containing 2.5% by mass of polyvinyl butyral (trade name “Denka butyral” #6000C, manufactured by Denka Company Limited) and 170 parts of 1,2-dimethoxyethane were further added and mixed, thereby preparing an undercoat layer-forming coating liquid P1.

### (Preparation of Single-Layer Type Photosensitive Layer-Forming Coating Liquid Q1)

To 793.35 parts of a mixed solvent of tetrahydrofuran (hereinafter appropriately abbreviated as THF) and toluene (hereinafter appropriately abbreviated as TL) (THF: 80% by mass, TL: 20% by mass), 2.6 parts of D-type titanyl phthalocyanine showing a clear peak at a diffraction angle of 2θ=27.3°±0.2° in powder X-ray diffraction using CuKα rays, 1.3 parts of a perylene pigment 1 having the following structure, 0.5 part of a polyvinyl butyral resin, 100 parts of the following hole transport material (HTM48, molecular weight of 748), 60 parts of the following electron transport material (ET-2, molecular weight of 424.2), 100 parts of a polycarbonate resin having a biphenyl structure, and 0.05 part of a silicone oil (tradename: KF-96, manufactured by Shin-Etsu Chemical Co., Ltd.) as a leveling agent were added and mixed, thereby preparing a single-layer type photosensitive layer-forming coating liquid Q1 having a solid content concentration of 25% by mass.

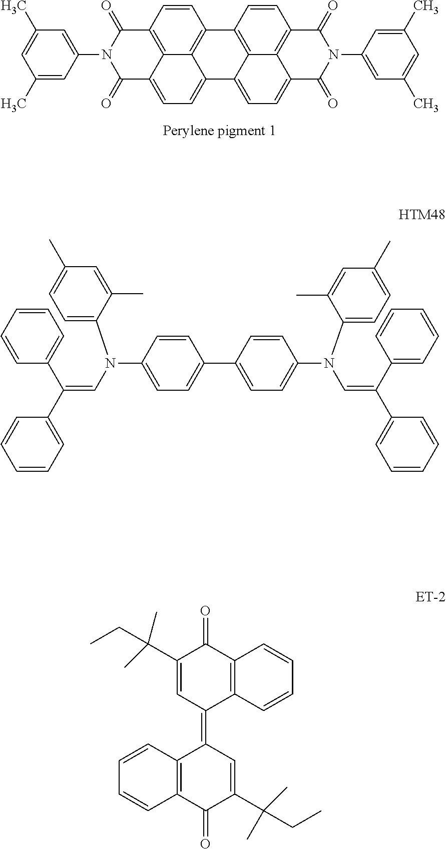

### (Preparation of Protective Layer-Forming Coating Liquid S1)

A curable compound M1 (product name: TMPT, manufactured by SHIN-NAKAMURA CHEMICAL Co., Ltd.) having the following structure and characteristics shown in Table 1, previously dissolved in a mixed solvent of methanol/1-propanol/toluene, benzophenone and Omnirad TPO H (2,4,6-trimethylbenzoyl-diphenyl phosphine oxide) as polymerization initiators, and titanium oxide particles (average primary particle diameter of 40 nm, surface treated with 7% by mass of 3-methacryloyloxypropyltrimethoxysilane) dispersion slurry were mixed to prepare a protective layer-forming coating liquid S1 (solid content concentration of 27.0% by mass) in which the mass ratio of TMPT/titanium oxide particles/benzophenone/Omnirad TPO H was 100/100/1/2 and the mass ratio of the solvent composition of methanol/1-propanol/toluene was 7/1/2.

The characteristics of the curable compound M1 used, such as molecular weight (X), number of acryloyl and methacryloyl groups in one molecule (Y), functional group equivalent (X/Y), and number of oxyalkylene groups in one molecule, are shown in Table 1.

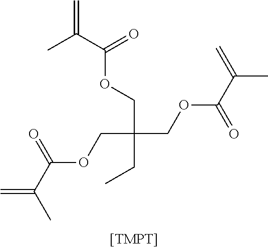 [SMILES: C=C(C)C(=O)OCC(CC)(COC(=O)C(=C)C)COC(=O)C(=C)C]

### (Preparation of Protective Layer-Forming Coating Liquid S2)

A protective layer-forming coating liquid S2 (solid content concentration of 27.0% by mass) was prepared in the same manner as in the protective layer-forming coating liquid S1, except that a curable compound M2 (product name: GLY-9E, manufactured by SHIN-NAKAMVURA CHEMICAL Co., Ltd.) having the following structure and characteristics shown in Table 1 was used instead of the curable compound M1.

The characteristics of the curable compound M2 used, such as molecular weight (X), number of acryloyl and methacryloyl groups in one molecule (Y), functional group equivalent (X/Y), and number of oxyalkylene groups in one molecule, are shown in Table 1.

In the following structural formula, R is an oxyalkylene group represented by —O—CH₂—CH₂—, and the sum of l, m, and n is 9.

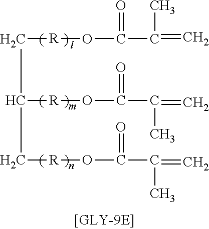

### (Preparation of Protective Layer-Forming Coating Liquid S3)

A protective layer-forming coating liquid S3 (solid content concentration of 27.0% by mass) was prepared in the same manner as in the protective layer-forming coating liquid S1, except that a curable compound M3 (product name: TM-4E, manufactured by SHIN-NAKAMURA CHEMICAL Co., Ltd.) having the following structure and characteristics shown in Table 1 was used instead of the curable compound M1.

The characteristics of the curable compound M3 used, such as molecular weight (X), number of acryloyl and methacryloyl groups in one molecule (Y), functional group equivalent (X/Y), and number of oxyalkylene groups in one molecule, are shown in Table 1.

### [TM-4E]

TM-4E is a compound represented by the above general formula (1′).

However, in the general formula (1′), each R is an oxyalkylene group represented by —O—CH₂—CH₂—, l+m+n+o=4, Q is the above formula (3′), and each Z¹ is a methyl group.

### (Preparation of Protective Layer-Forming Coating Liquid S4)

A protective layer-forming coating liquid S4 (solid content concentration of 27.0% by mass) was prepared in the same manner as in the protective layer-forming coating liquid S1, except that a curable compound M4 (product name: TM-4P, manufactured by SHIN-NAKAMURA CHEMICAL Co., Ltd.) having the following structure and characteristics shown in Table 1 was used instead of the curable compound M1.

The characteristics of the curable compound M4 used, such as molecular weight (X), number of acryloyl and methacryloyl groups in one molecule (Y), functional group equivalent (X/Y), and number of oxyalkylene groups in one molecule, are shown in Table 1.

### [TM-4P]

TM-4P is a compound represented by the above general formula (1′).

However, in the general formula (1′), each R is an oxyalkylene group represented by —O—CH(CH₃)—CH₂—, l+m+n+o=4, Q is the above formula (3′), and each Z¹ is a methyl group.

### (Preparation of Protective Layer-Forming Coating Liquid S5)

A protective layer-forming coating liquid S5 (solid content concentration of 27.0% by mass) was prepared in the same manner as in the protective layer-forming coating liquid S1, except that a curable compound M5 (product name: M-DPH-6E, manufactured by SHIN-NAKAMURA CHEMICAL Co., Ltd.) having the following structure and characteristics shown in Table 1 was used instead of the curable compound M1.

The characteristics of the curable compound M5 used, such as molecular weight (X), number of acryloyl and methacryloyl groups in one molecule (Y), functional group equivalent (X/Y), and number of oxyalkylene groups in one molecule, are shown in Table 1.

### [M-DPH-6E]

M-DPH-6E is a compound represented by the above general formula (2′).

However, in the general formula (2′), each R is an oxyalkylene group represented by —O—CH₂—CH₂—, f+g+h+i+j+k=6, Q is a hydroxy group or the above formula (3′), and each Z¹ is a methyl group.

### (Preparation of Protective Layer-Forming Coating Liquid S6)

A protective layer-forming coating liquid S6 (solid content concentration of 27.0% by mass) was prepared in the same manner as in the protective layer-forming coating liquid S1, except that a curable compound M6 (product name: M-DPH-12E, manufactured by SHIN-NAKAMURA CHEMICAL Co., Ltd.) having the following structure and characteristics shown in Table 1 was used instead of the curable compound M1.

The characteristics of the curable compound M6 used, such as molecular weight (X), number of acryloyl and methacryloyl groups in one molecule (Y), functional group equivalent (X/Y), and number of oxyalkylene groups in one molecule, are shown in Table 1.

### [M-DPH-12E]

M-DPH-12E is a compound represented by the above general formula (2′).

However, in the general formula (2′), each R is an oxyalkylene group represented by —O—CH₂—CH₂—, f+g+h+i+j+k=12, Q is a hydroxy group or the above formula (3′), and each Z¹ is a methyl group.

### (Preparation of Protective Layer-Forming Coating Liquid S7)

A protective layer-forming coating liquid S7 (solid content concentration of 27.0% by mass) was prepared in the same manner as in the protective layer-forming coating liquid S1, except that a curable compound M7 (product name: ATM-35E, manufactured by SHIN-NAKAMURA CHEMICAL Co., Ltd.) having the following structure and characteristics shown in Table 1 was used instead of the curable compound M1.

The characteristics of the curable compound M7 used, such as molecular weight (X), number of acryloyl and methacryloyl groups in one molecule (Y), functional group equivalent (X/Y), and number of oxyalkylene groups in one molecule, are shown in Table 1.

### [ATM-35E]

ATM-35E is a compound represented by the above general formula (1′).

However, in the general formula (1′), each R is an oxyalkylene group represented by —O—CH₂—CH₂—, l+m+n+o=35, Q is a hydroxy group or the above formula (3′), and each Z¹ is a hydrogen atom.

### (Preparation of Protective Layer-Forming Coating Liquid S8)

A protective layer-forming coating liquid S8 (solid content concentration of 27.0% by mass) was prepared in the same manner as in the protective layer-forming coating liquid S1, except that a curable compound M8 (product name: SR494, manufactured by Arkema K.K.) having the following structure and characteristics shown in Table 1 was used instead of the curable compound M1.

The characteristics of the curable compound M8 used, such as molecular weight (X), number of acryloyl and methacryloyl groups in one molecule (Y), functional group equivalent (X/Y), and number of oxyalkylene groups in one molecule, are shown in Table 1.

### [SR494]

SR-494 is a compound represented by the above general formula (1′).

However, in the general formula (1′), each R is an oxyalkylene group represented by —O—CH₂—CH₂—, l+m+n+o=4, Q is a hydroxy group or the above formula (3′), and each Z¹ is a hydrogen atom.

### (Preparation of Protective Layer-Forming Coating Liquid S9)

A protective layer-forming coating liquid S9 (solid content concentration of 27.0% by mass) was prepared in the same manner as in the protective layer-forming coating liquid S1, except that a curable compound M9 (product name: KAYARAD DPCA-120, manufactured by Nippon Kayaku Co., Ltd.) having the following structure and characteristics shown in Table 1 was used instead of the curable compound M1.

The characteristics of the curable compound M9 used, such as molecular weight (X), number of acryloyl and methacryloyl groups in one molecule (Y), functional group equivalent (X/Y), and number of groups represented by —O—(C═O)—(CH₂)ₚ— in one molecule, are shown in Table 1.

### [KAYARAD DPCA-120]

KAYARAD DPCA-120 is a compound represented by the above general formula (2′).

However, in the general formula (2′), each R is a group represented by —O—(C═O)—(CH₂)₅—, f+g+h+i+j+k=12, Q is a hydroxy group or the above formula (3′), and each Z¹ is a hydrogen atom.

### <Production of Single-Layer Photoconductor>

Single-layer photoconductors were produced by the following procedures.

### Comparative Example 1

The undercoat layer-forming coating liquid P1 was immersion-coated on an aluminum cylinder having a diameter of 30 mm and a length of 244 mm with a machined surface to form an undercoat layer having a film thickness of 0.3 μm after drying. The single-layer type photosensitive layer-forming coating liquid Q1 was immersion-coated on the undercoat layer and dried at 125° C. for 24 minutes to form a single-layer type photosensitive layer having a film thickness of 30 μm after drying. The protective layer-forming coating liquid S1 was ring-coated on the single-layer type photosensitive layer, dried at 50° C. for 5 minutes, and then irradiated with LED light of 365 nm at an intensity of 1.3 W/cm² for 2 minutes while rotating the photoconductor at 60 rpm under a nitrogen atmosphere to form a protective layer having a film thickness of 2 μm after drying, thereby producing a photoconductor A1.

### Comparative Example 2

A photoconductor A2 was produced in the same manner as in the photoconductor A1, except that the protective layer-forming coating liquid S1 was changed to the protective layer-forming coating liquid S2.

### Example 1

A photoconductor A3 was produced in the same manner as in the photoconductor A1, except that the protective layer-forming coating liquid S1 was changed to the protective layer-forming coating liquid S3.

### Example 2

A photoconductor A4 was produced in the same manner as in the photoconductor A1, except that the protective layer-forming coating liquid S1 was changed to the protective layer-forming coating liquid S4.

### Example 3

A photoconductor A5 was produced in the same manner as in the photoconductor A1, except that the protective layer-forming coating liquid S1 was changed to the protective layer-forming coating liquid S5.

### Example 4

A photoconductor A6 was produced in the same manner as in the photoconductor A1, except that the protective layer-forming coating liquid S1 was changed to the protective layer-forming coating liquid S6.

### Comparative Example 3

A photoconductor A7 was produced in the same manner as in the photoconductor A1, except that the protective layer-forming coating liquid S1 was changed to the protective layer-forming coating liquid S7.

### Comparative Example 4

A photoconductor A8 was produced in the same manner as in the photoconductor A1, except that the protective layer-forming coating liquid S1 was changed to the protective layer-forming coating liquid S8.

### Comparative Example 5

A photoconductor A9 was produced in the same manner as in the photoconductor A1, except that the protective layer-forming coating liquid S1 was changed to the protective layer-forming coating liquid S9.

### <Measurement of Martens Hardness and Elastic Deformation Rate>

For the photoconductors A1 to A9 obtained in Examples and Comparative Examples, the Martens hardness and the elastic deformation rate were measured from the surface side of each photoconductor using a microhardness tester (Fischerscope HM2000, manufactured by Fischer) in an environment of a temperature of 25° C. and a relative humidity of 50% under the following conditions. The Martens hardness and the elastic deformation rate of each sample are shown in Table 1.

### (Measurement Conditions of Martens Hardness and Elastic Deformation Rate)

Indenter: Vickers square pyramid diamond indenter with 1360 facing angle
Maximum indentation load: 0.2 mN
Time required to load: 10 seconds
Time required to unload: 10 seconds

The Martens hardness can be obtained by the following formula.

Martens hardness (N/mm²)=maximum indentation load/indentation area at maximum indentation load

The elastic deformation rate is a value defined by the following formula, and is the ratio of the work performed by a film elasticity during unloading to the total work required for indentation.

Elastic deformation rate (%)=(We/Wt)×100

In the formula, the total work Wt (nJ) represents an area surrounded by A-B-D-A in FIG. 2, and the elastic deformation work We (nJ) represents an area surrounded by C-B-D-C. The higher the elastic deformation ratio is, the less deformation remains under load, and an elastic deformation ratio of 100 means no residual deformation.

In Examples of the present invention, those having a Martens hardness of 230 N/mm² or more were judged to be “pass”, and those having an elastic deformation rate of 25% or more were judged to be “pass”.

### <Adhesion Test to Photosensitive Layer: Confirmation Test for Presence or Absence of Mixed Layer Formation>

Each of the protective layer-forming coating liquids S1 to S9 used in Examples and Comparative Examples was adhered to the surface of the single-layer type photosensitive layer obtained by the above-mentioned method before forming the protective layer, placed in an oven, and then allowed to stand at a set temperature of 50° C. for 10 minutes. The surface of the photosensitive layer was then wiped to observe whether any traces of each of the protective layer-forming coating liquids S1 to S9 remained on the surface, and the results were evaluated according to the following criteria. If adhesion traces remain, it can be said that a mixed layer tends to form.
◯ (very good): No adhesion traces were observed.
Δ (good): A few adhesion traces were observed, but not a problem in practical use.
X (poor): Adhesion traces were observed.

### <Evaluation of Electrical Characteristics>

Each of the photoconductors A1 to A9 obtained in Examples and Comparative Examples was allowed to stand in an environment of a temperature of 25° C. and a relative humidity of 50% for 16 hours, and then mounted on an electrophotographic characteristic evaluation apparatus (described in “Zoku Denshishashin Gijutu no Kiso to Oyo” (Sequel to Fundamentals and Applications of Electrophotographic Technology), edited by The Society of Electrophotography of Japan, Corona Publishing Co., Ltd., pp. 404 to 405), prepared in accordance with the measurement standard of The Society of Electrophotography of Japan, to thereby measure the electrical characteristics through cycles of charging, exposure, potential measurement, and static elimination as follows.

First, the grid voltage was regulated to charge the photoconductor so as to have an initial surface potential (V0) of +700 V. The photoconductor was then irradiated with exposure light of 1.0 μJ/cm² to measure a residual potential (VL) at 30 milliseconds after irradiation. The exposure light used was monochromatic light of 780 nm extracted from halogen lamp light through an interference filter.

The residual potential (VL) is shown in Table 1. A lower absolute value of the residual potential (VL) indicates better electrical characteristics. In Examples of the present invention, those having a residual potential (VL) of 90 V or less were judged to be “pass”.

### <Evaluation of Gas Resistance>

Each of the photoconductors A1, A3 to A5, and A7 to A9 obtained in Examples and Comparative Examples was allowed to stand in an environment of a temperature of 32° C. and a relative humidity of 80% for 16 hours, and then mounted on an electrophotographic characteristic evaluation apparatus (described in “Zoku Denshishashin Gijutu no Kiso to Oyo” (Sequel to Fundamentals and Applications of Electrophotographic Technology), edited by The Society of Electrophotography of Japan, Corona Publishing Co., Ltd., pp. 404 to 405), prepared in accordance with the measurement standard of The Society of Electrophotography of Japan. The photoconductor was then charged to have an initial surface potential (V0) of +700 V, and the charging and static elimination were repeated for 10,000 cycles to deteriorate the center of the photoconductor.

After the deterioration treatment, the photoconductor was installed in a printer, and tested for actual printing in an environment of a temperature of 32° C. and a relative humidity of 80%. The gas resistance of the photoconductor was evaluated by visually inspecting the images in the deteriorated and untreated areas. The following criteria were used in the evaluation.
◯ (good): No significant change was observed in the deteriorated area.
X (poor): White voids were observed in the deteriorated area.

TABLE 1

| | | Curable compound | | | | |
|---|---|---|---|---|---|---|
| | | | | Number of | | Number of |
| | Protective | | | acryloyl and | | oxyalkylene |
| | layer- | | | methacryloyl | Functional | groups or groups |
| | forming | | Molecular | groups in one | group | represented by |
| | coating | Product | weight | molecule | equivalent | —O—(C═O)—(CH₂)ₚ— |
| | liquid | name | X | Y | X/Y | in one molecule |
| Comparative | S1 | TMPT | 338.2 | 3 | 112.7 | — |
| Example 1 | | | | | | |
| Comparative | S2 | GLY-9E | 1484.8 | 3 | 494.9 | 9 |
| Example 2 | | | | | | |
| Comparative | S7 | ATM-35E | 1892 | 4 | 473.0 | 35 |
| Example 3 | | | | | | |
| Comparative | S8 | SR494 | 528 | 4 | 132.0 | 4 |
| Example 4 | | | | | | |
| Comparative | S9 | KAYARAD | 1947 | 6 | 324.5 | 12 |
| Example 5 | | DPCA-120 | | | | |
| Example 1 | S3 | TM-4E | 584.3 | 4 | 146.1 | 4 |
| Example 2 | S4 | TM-4P | 640.4 | 4 | 160.1 | 4 |
| Example 3 | S5 | M-DPH-6E | 926.5 | 6 | 154.4 | 6 |
| Example 4 | S6 | M-DPH-12E | 1190.6 | 6 | 198.4 | 12 |

| | | Elastic | Adhesion | | |
|---|---|---|---|---|---|
| | Martens | deformation | test on | Residual | |
| | hardness | rate | photosensitive | potential VL | Gas |
| | (N/mm²) | (%) | layer | (V) | resistance |
| Comparative | 298 | 37 | X | 121 | ◯ |
| Example 1 | | | | | |
| Comparative | 224 | 45 | X | 230 | |
| Example 2 | | | | | |
| Comparative | 113 | 46 | X | 136 | X |
| Example 3 | | | | | |
| Comparative | 306 | 36 | Δ | 86 | X |
| Example 4 | | | | | |
| Comparative | 102 | 20 | X | 91 | X |
| Example 5 | | | | | |
| Example 1 | 304 | 33 | ◯ | 84 | ◯ |
| Example 2 | 259 | 30 | ◯ | 54 | ◯ |
| Example 3 | 293 | 42 | ◯ | 60 | ◯ |
| Example 4 | 235 | 37 | Δ | 64 | |

### <Discussion>

The photoconductors in Examples 1 to 4 all had high Martens hardness and elastic deformation rates. It was also confirmed that the photoconductors in Examples 1 to 4 all had lower absolute values of residual potential (VL) than those in Comparative Examples 1 to 5, thereby preventing deterioration of the electrical characteristics, such as the residual potential characteristics where charges remain after exposure. The results of the adhesion test to the photosensitive layer showed that the photoconductors in Examples 1 to 4 all suppressed the formation of a mixed layer between the photosensitive layer and the protective layer compared to those in Comparative Examples 1 to 3 and 5.

In addition, the results of the gas resistance evaluation showed that the photoconductors in Examples 1 to 3 all had better gas resistance than those in Comparative Examples 3 to 5.

The curable compound M3 used in Example 1, the curable compound M5 used in Example 3, and the curable compound M6 used in Example 4 have the oxyalkylene group having 2 carbon atoms, the structure represented by the formula (5), and the structure represented by the formula (6) (where Z⁴ is a methyl group), which are the structures before polymerization.

The curable compound M4 used in Example 2 has the oxyalkylene group having 3 carbon atoms, the structure represented by the formula (5), and the structure represented by the formula (6) (where Z⁴ is a methyl group), which are the structures before polymerization.

The curable compounds used in the protective layers in Examples 1 to 4 do not have a side chain with low polarity as in the alkyl group, and have a structure in which groups with relatively high polarity C═O bonds (such as acryloyl and methacryloyl groups) or hydroxy groups are located on the outside of the molecule. The affinity between these polar groups located on the outside of the molecule and the relatively low-polarity photosensitive layer is low. Therefore, the formation of a mixed layer of mixing of the components of the protective layer and the photosensitive layer can be suppressed between the two layers, and as a result, it is considered that the deterioration of the residual potential characteristics can be prevented.

In addition, the curable compounds used in the protective layers in Examples 1 to 4 have at least one or more methacryloyl groups. With this configuration, acidic gases such as ozone are sterically inhibited from approaching the unreacted carbon-carbon double bond, thereby suppressing oxidative deterioration of the carbon-carbon double bond. For this reason, it is presumed that even in Example 4, where the gas resistance was not evaluated, the gas resistance was good (evaluation result: ◯), as in Examples 1 to 3.

From the results of the above Examples and Comparative Examples, as well as the results of the tests conducted by the present inventors to date, it can be concluded that when the protective layer contains a polymer having the structure represented by the formula (1) or (2), or a polymer having the group represented by R′, the structure represented by the formula (5), and the structure represented by the formula (6), i.e., when the protective layer is formed using a compound having the structure represented by the following formula (1′) or (2′), the Martens hardness and the elastic deformation rate on the surface of the photoconductor are high, and yet deterioration of the electrical characteristics, such as deterioration of the residual potential characteristics where charges remain after exposure, can be prevented, and the gas resistance can also be good.

In Examples 1 and 2, the sum of l, m, n, and o in the formula (1′) is 4, and the formation of a mixed layer can be suppressed by having polar groups located at the terminal side of the molecule without non-polar side chains, which can be considered that the same effect can be obtained when the sum of l, m, n, and o is 1 or more.

In Examples 1 and 2, R in the formula (1′) is —O—CH₂—CH₂— or —O—CH(CH₃)—CH₂—, and steric repulsion of polar groups located at the terminal side of the molecule can be suppressed, which can be considered that the same effect can be obtained even when R is an alkylene group having 1 or more and 8 or less carbon atoms, an oxyalkylene group having 1 or more and 8 or less carbon atoms, or —O—(C═O)—(CH₂)ₚ— (where p is 2 or more and 6 or less).

In Examples 1 and 2, Q in the formula (1′) is the following formula (3′), and the formation of a mixed layer can be suppressed by having polar groups located at the terminal side of the molecule, which can be considered that the same effect can be obtained even when Q is a hydroxy group.

It is presumed that the compound having the structure represented by the following formula (1′) reacts during curing of the protective layer and polymerizes by bonding the double bond at the terminal side of the molecule with reactive functional groups, resulting in a polymer having the structure represented by the formula (1).

In Examples 3 and 4, the sum of f, g, h, i, j, and k in the formula (2′) is 6 or 12, and the formation of a mixed layer can be suppressed by having polar groups located at the terminal side of the molecule without non-polar side chains, which can be considered that the same effect can be obtained when the sum of f, g, h, i, j, and k is 1 or more.

In Examples 3 and 4, R in the formula (2′) is —O—CH₂—CH₂—, and steric repulsion of polar groups located at the terminal side of the molecule can be suppressed, which can be considered that the same effect can be obtained even when R is an alkylene group having 1 or more and 8 or less carbon atoms, an oxyalkylene group having 1 or more and 8 or less carbon atoms, or —O—(C═O)—(CH₂)ₚ— (where p is 2 or more and 6 or less).

In Examples 3 and 4, Q in the formula (2′) is the following formula (3′) or a hydroxy group, and it can be considered that the same effect can be obtained regardless of which one is used.

It is presumed that the compound having the structure represented by the following formula (2′) reacts during curing of the protective layer and polymerizes by bonding the double bond at the terminal side of the molecule with reactive functional groups, resulting in a polymer having the structure represented by the formula (2).

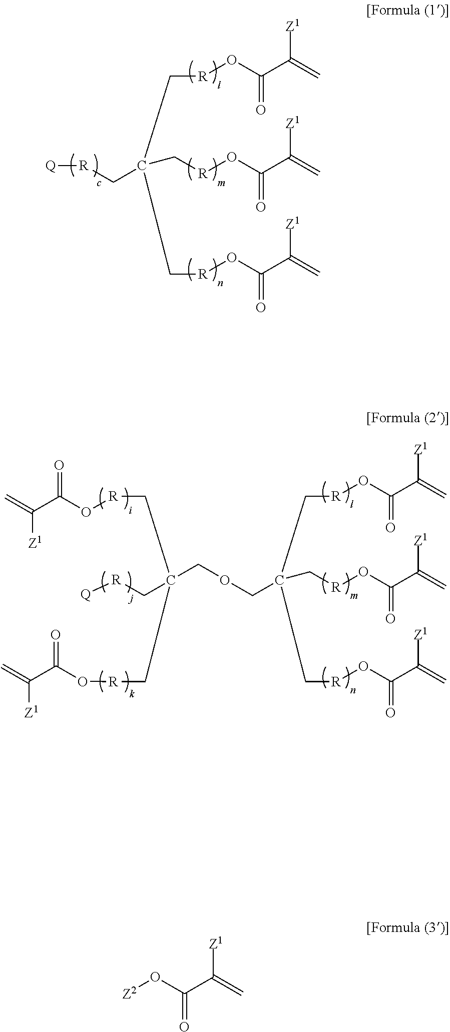

In the formula (3′), Z² represents a bonding hand with R in the formula (1′) or (2′). Z¹ represents a hydrogen atom or an alkyl group having 1 or more and 4 or less carbon atoms.

### EXPLANATIONS OF LETTERS OR NUMERALS

1 Photoconductor (Electrophotographic Photoconductor)
2 Charging Device (Charging Roller; Charging Section)
3 Exposing Device (Exposing Section)
4 Developing Device (Developing Section)
5 Transferring Device
6 Cleaning Device
7 Fixing Device
41 Developing Tank
42 Agitator
43 Supplying Roller
44 Developing Roller
45 Regulating Member
71 Upper Fixing Member (Pressure Roller)
72 Lower Fixing Member (Fixing Roller)
73 Heating Device
T Toner
P Printing Paper (Paper, Medium)

1. An electrophotographic photoconductor comprising a photosensitive layer and a protective layer in sequence on a conductive support,
the protective layer containing a polymer having a structure represented by the following formula (1) or (2): 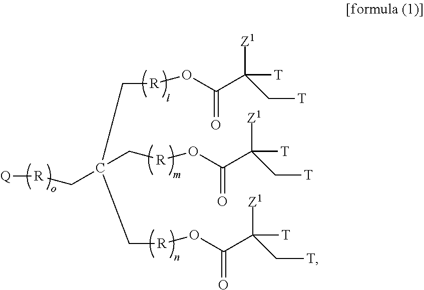
wherein l, m, n, and o are each an integer of 0 or more and 10 or less and a sum of l, m, n, and o is 1 or more, each R independently represents a divalent group selected from an alkylene group having 1 or more and 8 or less carbon atoms, an oxyalkylene group having 1 or more and 8 or less carbon atoms, and —O—(C═O)—(CH₂)ₚ— (where p is 2 or more and 6 or less), T represents a bonding hand with arbitrary atoms, Q represents a hydroxy group or the following formula (3), and each Z¹ independently represents a hydrogen atom or an alkyl group having 1 or more and 4 or less carbon atoms, at least one of which represents an alkyl group having 1 or more and 4 or less carbon atoms; 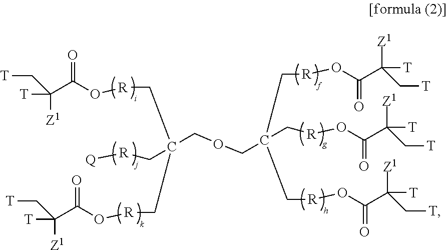
wherein f, g, h, i, j, and k are each an integer of 0 or more and 10 or less and a sum of f, g, h, i, j, and k is 1 or more, each R independently represents a divalent group selected from an alkylene group having 1 or more and 8 or less carbon atoms, an oxyalkylene group having 1 or more and 8 or less carbon atoms, and —O—(C═O)—(CH₂)ₚ— (where p is 2 or more and 6 or less), T represents a bonding hand with arbitrary atoms, Q represents a hydroxy group or the following formula (3), and each Z¹ independently represents a hydrogen atom or an alkyl group having 1 or more and 4 or less carbon atoms, at least one of which represents an alkyl group having 1 or more and 4 or less carbon atoms; and 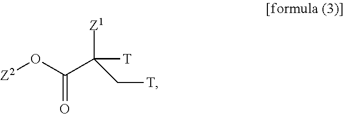
wherein Z² represents a bonding hand with R in the formula (1) or (2), Z¹ represents a hydrogen atom or an alkyl group having 1 or more and 4 or less carbon atoms, and T represents a bonding hand with arbitrary atoms.

2. The electrophotographic photoconductor according to claim 1, wherein the protective layer contains the polymer having the structure represented by formula (1).

3. The electrophotographic photoconductor according claim 1, wherein the protective layer comprises a polymer of a compound a having a structure represented by the following formula (1′) or a polymer of a compound b having a structure represented by the following formula (2′): 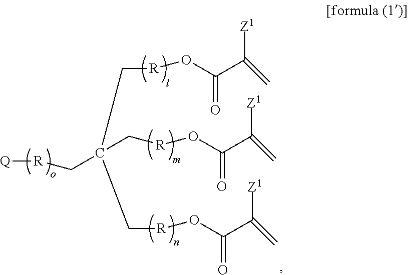
wherein l, m, n, and o are each an integer of 0 or more and 10 or less and a sum of l, m, n, and o is 1 or more, each R independently represents a divalent group selected from an alkylene group having 1 or more and 8 or less carbon atoms, an oxyalkylene group having 1 or more and 8 or less carbon atoms, and —O—(C═O)—(CH₂)ₚ— (where p is 2 or more and 6 or less), Q represents a hydroxy group or the following formula (3′), and each Z¹ independently represents a hydrogen atom or an alkyl group having 1 or more and 4 or less carbon atoms, at least one of which represents an alkyl group having 1 or more and 4 or less carbon atoms; 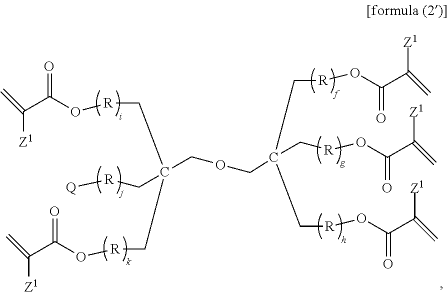
wherein f, g, h, i, j, and k are each an integer of 0 or more and 10 or less and a sum of f, g, h, i, j, and k is 1 or more, each R independently represents a divalent group selected from an alkylene group having 1 or more and 8 or less carbon atoms, an oxyalkylene group having 1 or more and 8 or less carbon atoms, and —O—(C═O)—(CH₂)ₚ— (where p is 2 or more and 6 or less), Q represents a hydroxy group or the following formula (3′), and each Z¹ independently represents a hydrogen atom or an alkyl group having 1 or more and 4 or less carbon atoms, at least one of which represents an alkyl group having 1 or more and 4 or less carbon atoms; and 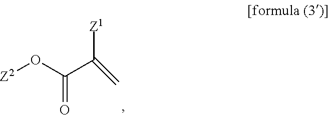
wherein Z² represents a bonding hand with R in the formula (1′) or (2′), and Z¹ represents a hydrogen atom or an alkyl group having 1 or more and 4 or less carbon atoms.

4. The electrophotographic photoconductor according to claim 1, wherein the protective layer comprises a polymer of a compound a having a structure represented by the following formula (1′): 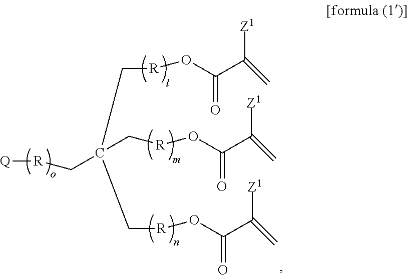
wherein l, m, n, and o are each an integer of 0 or more and 10 or less and a sum of l, m, n, and o is 1 or more, each R independently represents a divalent group selected from an alkylene group having 1 or more and 8 or less carbon atoms, an oxyalkylene group having 1 or more and 8 or less carbon atoms, and —O—(C═O)—(CH₂)ₚ— (where p is 2 or more and 6 or less), Q represents a hydroxy group or the following formula (3′), and each Z¹ independently represents a hydrogen atom or an alkyl group having 1 or more and 4 or less carbon atoms, at least one of which represents an alkyl group having 1 or more and 4 or less carbon atoms; and 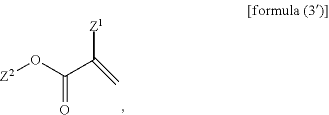
wherein Z² represents a bonding hand with R in the formula (1′) or (2′), and Z¹ represents a hydrogen atom or an alkyl group having 1 or more and 4 or less carbon atoms.

5. The electrophotographic photoconductor according to claim 1, wherein each R in the formula (1) or (2) represents an oxyalkylene group having 1 or more and 8 or less carbon atoms.

6. The electrophotographic photoconductor according to claim 1, wherein the protective layer contains metal oxide particles.

7. The electrophotographic photoconductor according to claim 1, wherein the protective layer comprises a layer cured by irradiation with ultraviolet light and/or visible light.

8. The electrophotographic photoconductor according to claim 1, wherein the photosensitive layer comprises a single-layer photosensitive layer containing both a charge generation material and a charge transport material in the same layer.

9. The electrophotographic photoconductor according to claim 3, wherein a molecular weight X of the compound a or b represented by the formula (1′) or (2′) and a number Y of acryloyl and methacryloyl groups in one molecule satisfy the following formula (4):
$$120 \leq X / Y \leq 400. \qquad ( 4 )$$

10. The electrophotographic photoconductor according to claim 3, wherein the molecular weight X of the compound a or b represented by the formula (1′) or (2′) is 550 or more and 1,400 or less.

11. The electrophotographic photoconductor according to claim 1, wherein l, m, n, and o in the formula (1) are each an integer of 0 or more and 8 or less.

12. The electrophotographic photoconductor according to claim 1, wherein a sum of l, m, n, and o in the formula (1) is 1 or more and 12 or less.

13. The electrophotographic photoconductor according to claim 1, wherein a sum of f, g, h, i, j, and k in the formula (2) is 1 or more and 18 or less.

14. An electrophotographic photoconductor comprising a photosensitive layer and a protective layer in sequence on a conductive support,
the protective layer containing a polymer having a group represented by the following R′, a structure represented by the following formula (5), and a structure represented by the following formula (6):
wherein R′ represents a divalent group selected from an alkylene group having 1 or more and 8 or less carbon atoms, an oxyalkylene group having 1 or more and 8 or less carbon atoms, and —O—(C═O)—(CH₂)ₚ— (where p is 2 or more and 6 or less); 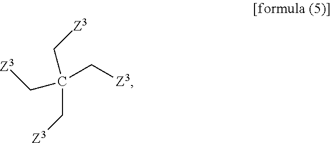
wherein Z³ represents a bonding hand with arbitrary atoms; and 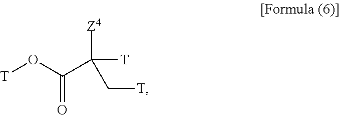
wherein Z⁴ represents an alkyl group having 1 or more and 4 or less carbon atoms, and T represents a bonding hand with arbitrary atoms.

15. An electrophotographic photoconductor cartridge comprising the electrophotographic photoconductor according to claim 1.

16. An image-forming apparatus comprising the electrophotographic photoconductor according to claim 1.
